(19) United States
(12) Patent Application Publication
(10) Pub. No.: US 2024/0383933 A1
(43) Pub. Date: Nov. 21, 2024

(54) Tethered Alkylidyne and Methods of Making the Same

(71) Applicants: UNIVERSITY OF FLORIDA RESEARCH FOUNDATION, INCORPORATED, Gainesville, FL (US); Government of the United States, as represented by the Secretary of the Air Force, Wright-Patterson Afb, OH (US)

(72) Inventors: Adam S. Veige, Gainesville, FL (US); Andrew Beauchamp, Gainesville, FL (US)

(21) Appl. No.: 18/692,598

(22) PCT Filed: Sep. 15, 2022
(86) PCT No.: PCT/US22/43643

§ 371 Date: Mar. 15, 2024

Related U.S. Application Data
(60) Provisional application No. 63/244,319, filed on Sep. 15, 2021.

(51) Int. Cl. C07F 11/00; C08F 4/78; C08G 61/04

(52) U.S. Cl. CPC C07F 11/00; C08F 4/78; C08G 61/04

(57) ABSTRACT

Provided herein are compounds that can be used as a catalyst to form cyclic polymers, and methods of making and using the same. For example, provided herein are compounds of formula (I), and formula (1-dimer).

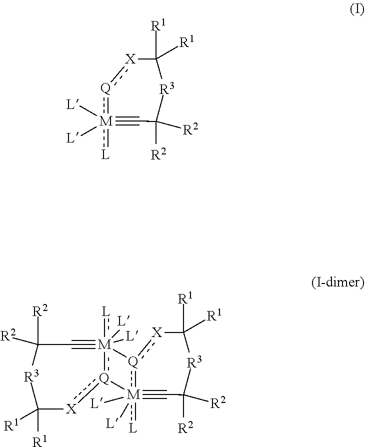

### CROSS-REFERENCE TO RELATED APPLICATIONS

This application claims the priority benefit under 35 U.S.C. § 119 (e) of U.S. Provisional Application No. 63/244,319, filed Sep. 15, 2021, the entire disclosure of which is incorporated herein by reference.

### STATEMENT OF US GOVERNMENT SUPPORT

This invention was made with government support under Grant Number 1856674, awarded by the National Science Foundation. The government has certain rights in the invention.

### BACKGROUND

Alkene and Alkyne metathesis catalysts are created by installing pendant alkene and alkyne groups on the ligand; however, traditional catalyst designs leave the metal-carbon multiple bond exposed which can cause formation of side-products or degradation of the catalyst. There is a need for catalysts that do not have an exposed metal carbon multiple bond. In addition, there is a need for catalysts that polymerize alkynes and/or alkenes by ring expansion metathesis polymerization (REMP) to yield cyclic polyalkyne(s) and/or polyalkene(s).

### SUMMARY

Provided herein are compounds having a structure represented by formula (I), or dimers thereof:

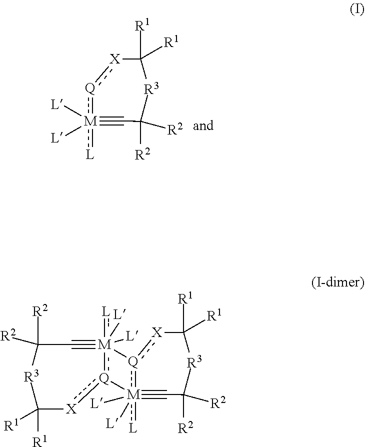

wherein the dashed lines are optional double bonds;
M is a transition metal;
L is a neutral or anionic ligand;
each L′ is independently absent or a neutral or anionic ligand;
Q is selected from S, O, N, NR⁵, N(R⁵)₂, P(R⁶)₂, C, CR⁷, C(R⁷)₂, BR⁸, Si(R⁹)₂, Se, and Te;
X is selected from a bond, S, O, N, NR⁵, Se, Te, C₁-C₄haloalkyl, C₁-C₄alkyl, C₂-C₄alkenyl, C₄-C₁₀cycloalkyl, Ar¹, C₁-C₄heteroalkyl comprising 1 to 5 heteroatoms selected from O, N, and S, and C₁-C₈heterocycloalkyl comprising 1 to 5 heteroatoms selected from O, N, and S;
R³ is selected from a bond, —C(R¹)₂—, —C(R¹)₂C(R¹)₂—, —C(R¹)₂C(R¹)₂C(R¹)₂—, —C(R¹)₂C(R¹)₂C(R¹)₂C(R¹)₂—, and —C(R¹)₂C(R¹)₂C(R¹)²C(R¹)₂C(R¹)₂—;
each R¹ is independently selected from H, C₁-C₂₀haloalkyl, C₁-C₂₀alkyl, C₂-C₂₀alkenyl, C₄-C₂₀cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two geminal R¹ together with the carbon atom to which they are attached, form a five- to eight-member cycloalkyl or heterocycloalkyl comprising 1 to 5 heteroatoms selected from O, N, and S, or two vicinal R¹ together with the carbon atoms to which they are attached, form a six-member aryl or heteroaryl comprising 1 to 4 heteroatoms selected from O, N, and S, or a five- to eight-member cycloalkyl or heterocycloalkyl comprising 1 to 5 heteroatoms selected from O, N, and S;
each R² is independently selected from H, C₁-C₂₀haloalkyl, C₁-C₂₀alkyl, C₂-C₂₀alkenyl, C₄-C₂₀cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S, or both R² together with the carbon atoms to which they are attached, form a five- to eight-member cycloalkyl or heterocycloalkyl comprising 1 to 5 heteroatoms selected from O, N, and S;
each R⁶ and R⁹ are independently selected from C₁-C₂₂ alkyl, C₄-C₈ cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two vicinal R⁵, two vicinal R⁶, two vicinal R⁸, or two vicinal R⁹, together with the atoms to which they are attached, form a five- to eight-member cycloalkyl, aryl, heteroaryl, or heterocycloalkyl comprising 1 to 5 heteroatoms selected from O, N, and S;
each R⁵, R⁷, and R⁸ are independently selected from H, C₁-C₂₂ alkyl, C₄-C₈ cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two vicinal R⁷ together with the atoms to which they are attached, form a five- to eight-member cycloalkyl, aryl, heteroaryl, or heterocycloalkyl comprising 1 to 5 heteroatoms selected from O, N, and S; and,
each Ar¹ is independently selected from C₆-C₂₂ aryl and a 5-12 membered heteroaryl comprising from 1 to 3 ring heteroatoms selected from O, N, and S.

Also provided herein are compounds having the structures:

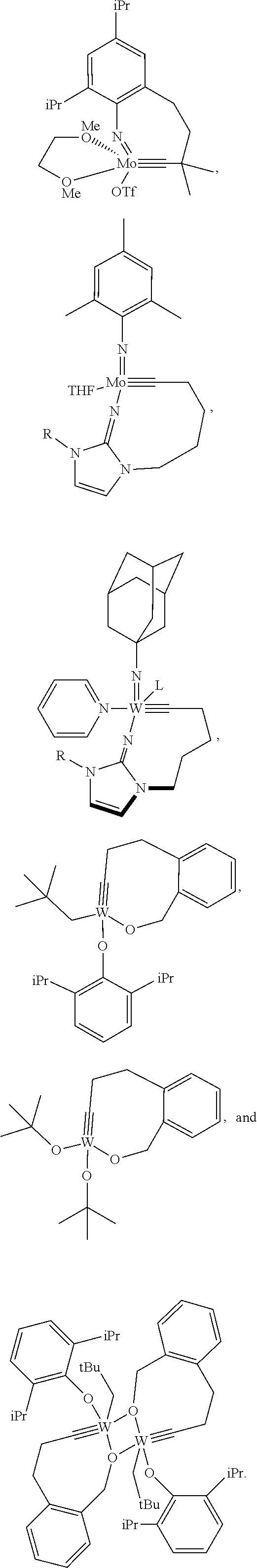

Also provided herein are methods of preparing the compounds of formula (I), and dimers thereof, according to the disclosure, comprising:
admixing a compound of formula (II) and a compound of formula (III) to form a compound of formula (IV) or dimer thereof; and, admixing the compound of formula (IV) with a deprotonating agent to form a compound of formula (I) or dimer thereof:

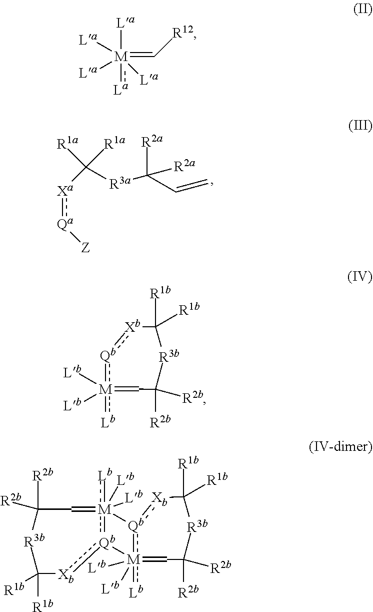

wherein the dashed lines are optional double bonds;
M is a transition metal;
L^{a} and L^{b} are neutral or anionic ligands;
each L′^{a} is independently absent or a neutral or anionic ligand;
each L′^{b} is independently absent or a neutral or anionic ligand;
Q^{a} is selected from S, O, N, NR^{5a}, N(R^{5a})₂, P(R^{6a})₂, C, CR^{7a}, C(R^{7a})₂, BR^{8a}, Si(R^{9a})₂, Se, and Te;
Q^{b} is selected from S, O, N, NR^{5b}, N(R^{5b})₂, P(R^{6b})₂, C, CR^{7b}, C(R^{7b})₂, BR^{8b}, Si(R^{9b})₂, Se, and Te;
Z is selected from H, halo, or a counterion for Q^{a};
X^{a} is selected from a bond, S, O, N, NR^{5a}, Se, Te, C₁-C₄haloalkyl, C₁-C₄alkyl, C₂-C₄alkenyl, C₄-C₁₀cycloalkyl, Ar^{1a}, C₁-C₄heteroalkyl comprising 1 to 5 heteroatoms selected from O, N, and S, and C₁-C₈heterocycloalkyl comprising 1 to 5 heteroatoms selected from O, N, and S;
X^{b} is selected from a bond, S, O, N, NR^{5b}, Se, Te, C₁-C₄haloalkyl, C₁-C₄alkyl, C₂-C₄alkenyl, C₄-C₁₀cycloalkyl, Ar^{1b}, C₁-C₄heteroalkyl comprising 1 to 5 heteroatoms selected from O, N, and S, and C₁-C₈heterocycloalkyl comprising 1 to 5 heteroatoms selected from O, N, and S;
R^{3a} is selected from a bond, —C(R^{1a})₂—, —C(R^{1a})₂C(R^{1a})₂—, —C(R^{1a})₂C(R^{1a})₂C(R^{1a})₂—, —C(R^{1a})₂C(R^{1a})₂C(R^{1a})₂C(R^{1a})₂—, and —C(R^{1a})₂C(R^{1a})₂C(R^{1a})₂C(R^{1a})₂C(R^{1a})₂—;
R^{3b} is selected from a bond, —C(R^{1b})₂—, —C(R^{1b})₂C(R^{1b})₂—, —C(R^{1b})₂C(R^{1b})₂C(R^{1b})₂—, —C(R^{1b})₂C(R^{1b})₂C(R^{1b})₂C(R^{1b})₂—, and —C(R^{1b})₂C(R^{1b})₂C(R^{1b})₂C(R^{1b})₂C(R^{1b})₂—;
each R^{1a} is independently selected from H, C₁-C₂₀haloalkyl, C₁-C₂₀alkyl, C₂-C₂₀alkenyl, C₄-C₂₀cycloalkyl, Ar^{1a}, C₁-C₂₀heteroalkyl comprising 1 to 5 heteroatoms selected from O, N, and S, and C₁-C₂₀heterocycloalkyl comprising 1 to 5 heteroatoms selected from O, N, and S, two geminal R^{1a} together with the carbon atoms to which they are attached, form a five- to eight-member cycloalkyl or heterocycloalkyl comprising 1 to 5 heteroatoms selected from O, N, and S, or two vicinal R^{1a} together with the carbon atoms to which they are attached, form a six-member aryl or heteroaryl comprising 1 to 4 heteroatoms selected from O, N, and S, or a five- to eight-member cycloalkyl or heterocycloalkyl comprising 1 to 5 heteroatoms selected from O, N, and S;
each R^{1b} is independently selected from H, C₁-C₂₀haloalkyl, C₁-C₂₀alkyl, C₂-C₂₀alkenyl, C₄-C₂₀cycloalkyl, Ar^{1b}, C₁-C₂₀heteroalkyl comprising 1 to 5 heteroatoms selected from O, N, and S, and C₁-C₂₀heterocycloalkyl comprising 1 to 5 heteroatoms selected from O, N, and S, two geminal R^{1b} together with the carbon atoms to which they are attached, form a five- to eight-member cycloalkyl or heterocycloalkyl comprising 1 to 5 heteroatoms selected from O, N, and S, or two vicinal R^{1b} together with the carbon atoms to which they are attached, form a six-member aryl or heteroaryl comprising 1 to 4 heteroatoms selected from O, N, and S, or a five- to eight-member cycloalkyl or heterocycloalkyl comprising 1 to 5 heteroatoms selected from O, N, and S;
each R^{2a} is independently selected from H, C₁-C₂₀haloalkyl, C₁-C₂₀alkyl, C₂-C₂₀alkenyl, C₄-C₂₀cycloalkyl, Ar^{1a}, C₁-C₂₀heteroalkyl comprising 1 to 5 heteroatoms selected from O, N, and S, and C₁-C₂₀heterocycloalkyl comprising 1 to 5 heteroatoms selected from O, N, and S, or both R^{2a} together with the carbon atoms to which they are attached, form a five- to eight-member cycloalkyl or heterocycloalkyl comprising 1 to 5 heteroatoms selected from O, N, and S;
each R^{2b} is independently selected from H, C₁-C₂₀haloalkyl, C₁-C₂₀alkyl, C₂-C₂₀alkenyl, C₄-C₂₀cycloalkyl, Ar^{1b}, C₁-C₂₀heteroalkyl comprising 1 to 5 heteroatoms selected from O, N, and S, and C₁-C₂₀heterocycloalkyl comprising 1 to 5 heteroatoms selected from O, N, and S, or both R^{2b} together with the carbon atoms to which they are attached, form a five- to eight-member cycloalkyl or heterocycloalkyl comprising 1 to 5 heteroatoms selected from O, N, and S;
each R^{5a}, R^{6a}, R^{7a}, R^{8a} and R^{9a} is independently selected from C₁-C₂₂ alkyl, C₄-C₈ cycloalkyl, Ar^{1a}, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two vicinal R^{5a}, two vicinal R^{6a}, two vicinal R^{7a}, two vicinal R^{8a}, or two vicinal R^{9a}, together with the atoms to which they are attached, form a five- to eight-member cycloalkyl, aryl, heteroaryl, or heterocycloalkyl comprising 1 to 5 heteroatoms selected from O, N, and S;
each R^{5b}, R^{6b}, R^{7b}, R^{8b} and R^{9b} is independently selected from C₁-C₂₂ alkyl, C₄-C₈ cycloalkyl, Ar^{1b}, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two vicinal R^{5b}, two vicinal R^{6b}, two vicinal R^{7b}, two vicinal R^{8b}, or two vicinal R^{9b}, together with the atoms to which they are attached, form a five- to eight-member cycloalkyl, aryl, heteroaryl, or heterocycloalkyl comprising 1 to 5 heteroatoms selected from O, N, and S;
each Ar^{1a} and Ar^{1b} are independently selected from C₆-C₂₂ aryl and a 5-12 membered heteroaryl comprising from 1 to 3 ring heteroatoms selected from O, N, and S.

Also provided herein is a cyclic polymer having a structure according to formula (V):

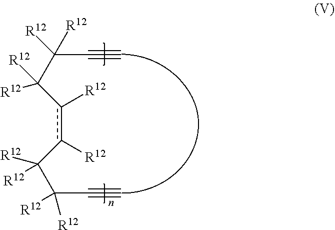

wherein the dashed line is an optional double or triple bond;
each R¹² is independently absent, H, C₁-C₂₀haloalkyl, C₁-C₂₀alkyl, C₂-C₂₀alkenyl, C₄-C₂₀cycloalkyl, aryl, heteroaryl comprising 1 to 5 heteroatoms selected from O, N, and S, C₁-C₂₀alkoxy, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two vicinal R¹² together with the carbon atoms to which they are attached, form a five- to eight-member cycloalkyl, heterocycloalkyl comprising 1 to 5 heteroatoms selected from O, N, and S, aryl, or heteroaryl comprising 1 to 5 heteroatoms selected from O,N, and S;
and n is an integer of at least 2.

Also provided herein are methods of preparing cyclic polymers of formula V or VI, the method comprising: admixing a plurality alkene monomers, alkyne monomers, or both in the presence of the compounds of formula (I), or dimers thereof, of the disclosure under conditions sufficient to polymerize the plurality of alkene monomers, alkyne monomers, or both to form the cyclic polymer.

### BRIEF DESCRIPTION OF DRAWINGS

FIG. 1 is a reaction scheme for the preparation of a ligand for a compound of formula (I), or dimer thereof, of the disclosure.

FIG. 2 is a 1-D NOESY/EXSY spectrum of W(CCH₂CH₂C₆H₄-o-CH₂O)(CH^{t}Bu)(O-2,6-ⁱPr²—C₆H₃) (C₆D₆, 500 MHz, 25° C.).

FIG. 3 is the molecular structure of a catalyst of the disclosure, with non-carbon atoms labelled, and having ligand and solvent disorder parts and hydrogen atoms removed for clarity.

FIG. 4 is a stacked ¹H NMR spectrum of W(CCH₂CH₂C₆H₄-o-CH₂O)(CH^{t}Bu)(O-2,6-ⁱPr₂—C₆H₃), (bottom), 3,8-didodecyloxy-5,6-dihydro-11,12-didehydrodibenzo[a,e]-[8]annulen (2nd), and polymerization progress (top 3 spectra).

FIG. 5 is a plot of the log of molecular weight versus elution volume for linear and cyclic poly-(o-phenylene ethynylene) formed according to an embodiment of the invention (Run 1).

FIG. 6 is a plot of the log of molecular weight versus elution volume for linear and cyclic poly-(o-phenylene ethynylene) formed according to an embodiment of the invention (Run 2).

FIG. 7 is a plot of log (intrinsic viscosity) vs log (viscosity-average molar mass) for linear and cyclic poly-(o-phenylene ethynylene) formed according to an embodiment of the invention (Run 1).

FIG. 8 is a plot of log (intrinsic viscosity) vs log (viscosity-average molar mass) for linear and cyclic poly-(o-phenylene ethynylene) formed according to an embodiment of the invention (Run 2).

FIG. 9 is a plot of <R_{g}²> vs molar mass for linear and cyclic poly-(o-phenylene ethynylene) formed according to an embodiment of the invention, where <R_{g}²> is the mean square radius (Run 1).

FIG. 10 is a plot of <R_{g}²> vs molar mass for linear and cyclic poly-(o-phenylene ethynylene) formed according to an embodiment of the invention, where <R_{g}²> is the mean square radius (Run 2).

### DETAILED DESCRIPTION

Provided herein are compounds having a structure represented by formulas (I), (II), (III), (IV), (V), and (VI), and methods of making and using said compounds. In embodiments, compounds having a structure represented by formulas (I) and (IV) can be in the form of a dimer. Compounds having a structure represented by formula (I), and dimers thereof, can be used as a catalyst in the preparation of cyclic polymers. Advantageously, compounds having a structure represented by formula (I), or dimers thereof, can generate high-molecular weight cyclic polyalkynes.

The compounds of the disclosure have structures represented by formulas (I), (II), (III), (IV), (V), and (VI) and these compounds may also be referred to as “compounds of formula (I),” “compounds of formula (II),” “compounds of formula (III)”, “compounds of formula (IV),” “compounds of formula (V),” and “compounds of formula (VI),” herein, respectively.

Modifications and other embodiments will come to mind to one skilled in the art to which the disclosed compositions and methods pertain having the benefit of the teachings presented herein and the associated drawings. Therefore, it is to be understood that the disclosures are not to be limited to the specific embodiments disclosed and that modifications and other embodiments are intended to be included within the scope of the appended claims.

It is also to be understood that the terminology used herein is for the purpose of describing particular aspects only and is not intended to be limiting. As used in the specification and in the claims, the term “comprising” can include the aspect of “consisting of.” Unless defined otherwise, all technical and scientific terms used herein have the same meaning as commonly understood by one of ordinary skill in the art to which the disclosed compositions and methods belong. In this specification and in the claims which follow, reference will be made to a number of terms which shall be defined herein.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

### Definitions

As used herein, the term “alkyl” refers to straight chained and branched saturated hydrocarbon groups containing one to thirty carbon atoms, for example, one to twenty two carbon atoms, or one to twenty carbon atoms, or one to ten carbon atoms. The term Cₙ means the alkyl group has “n” carbon atoms. For example, C₄ alkyl refers to an alkyl group that has 4 carbon atoms. C₁₋₂₀alkyl and C₁-C₂₀ alkyl refer to an alkyl group having a number of carbon atoms encompassing the entire range (i.e., 1 to 20 carbon atoms), as well as all subgroups (e.g., 1-20, 2-15, 1-10, 5-12, 1, 2, 3, 4, 5, 6, 7, 8, 9, 10, 11, 12, 13, 14, 15, 16, 17, 18, 19, and 20 carbon atoms). Nonlimiting examples of alkyl groups include, methyl, ethyl, n-propyl, isopropyl, n-butyl, sec-butyl (2-methylpropyl), t-butyl (1,1-dimethylethyl), 3,3-dimethylpentyl, and 2-ethylhexyl. Unless otherwise indicated, an alkyl group can be an unsubstituted alkyl group or a substituted alkyl group. Unless otherwise indicated, an alkyl group can be an unsubstituted alkyl group or a substituted alkyl group. A specific substitution on an alkyl can be indicated by inclusion in the term, e.g., “haloalkyl” indicates an alkyl group substituted with one or more (e.g., one to 10) halogens.

As used herein, the term “heteroalkyl” is defined similarly as alkyl except that the straight chained and branched saturated hydrocarbon group contains, in the alkyl chain, one to five heteroatoms independently selected from oxygen (O), nitrogen (N), and sulfur(S). In particular, the term “heteroalkyl” refers to a saturated hydrocarbon containing one to twenty carbon atoms and one to five heteroatoms. In general, in embodiments wherein the heteroalkyl is provided as a substituent, the heteroalkyl is bound through a carbon atom, e.g., a heteroalkyl is distinct from an alkoxy or amino group.

As used herein, the term “cycloalkyl” refers to an aliphatic cyclic hydrocarbon group containing four to twenty carbon atoms, for example, four to fifteen carbon atoms, or four to ten carbon atoms (e.g., 4, 5, 6, 7, 8, 10, 12, 14, 15, 16, 17, 18, 19 or 20 carbon atoms). The term Cₙ means the cycloalkyl group has “n” carbon atoms. For example, C₅ cycloalkyl refers to a cycloalkyl group that has 5 carbon atoms in the ring. C₅₋₈ cycloalkyl and C₅-C₈ cycloalkyl refer to cycloalkyl groups having a number of carbon atoms encompassing the entire range (i.e., 5 to 8 carbon atoms), as well as all subgroups (e.g., 5-6, 6-8, 7-8, 5-7, 5, 6, 7, and 8 carbon atoms). Nonlimiting examples of cycloalkyl groups include cyclobutyl, cyclopentyl, cyclohexyl, cycloheptyl, and cyclooctyl. Unless otherwise indicated, a cycloalkyl group can be an unsubstituted cycloalkyl group or a substituted cycloalkyl group. The cycloalkyl groups described herein can be isolated or fused to another cycloalkyl group, a heterocycloalkyl group, an aryl group and/or a heteroaryl group, or a bicyclic group or a tricyclic group. For example, the cycloalkyl groups described herein can be a cyclohexyl fused to another cyclohexyl, or an adamantyl.

As used herein, the term “heterocycloalkyl” is defined similarly as cycloalkyl, except the ring contains one to five heteroatoms independently selected from oxygen, nitrogen, and sulfur. In particular, the term “heterocycloalkyl” refers to a ring containing a total of five to twenty atoms, for example three to fifteen atoms, or three to ten atoms, of which 1, 2, 3, 4, or 5 of those atoms are heteroatoms independently selected from the group consisting of oxygen, nitrogen, and sulfur, and the remaining atoms in the ring are carbon atoms. Nonlimiting examples of heterocycloalkyl groups include piperidine, tetrahydrofuran, tetrahydropyran, dihydrofuran, morpholine, and the like. The heterocycloalkyl groups described herein can be isolated or fused to another heterocycloalkyl group, a cycloalkyl group, an aryl group, and/or a heteroaryl group. In some embodiments, the heterocycloalkyl groups described herein comprise one oxygen ring atom (e.g., oxiranyl, oxetanyl, tetrahydrofuranyl, and tetrahydropyranyl).

As used herein, the term “alkenyl” is defined identically as “alkyl,” except for containing at least one carbon-carbon double bond, and having two to thirty carbon atoms, for example, two to twenty carbon atoms, or two to ten carbon atoms. The term Cₙ means the alkenyl group has “n” carbon atoms. For example, C₄ alkenyl refers to an alkenyl group that has 4 carbon atoms. C₂₋₇ alkenyl and C₂-C₇ alkenyl refer to an alkenyl group having a number of carbon atoms encompassing the entire range (i.e., 2 to 7 carbon atoms), as well as all subgroups (e.g., 2-6, 2-5, 3-6, 2, 3, 4, 5, 6, and 7 carbon atoms). Specifically contemplated alkenyl groups include ethenyl, 1-propenyl, 2-propenyl, and butenyl. Unless otherwise indicated, an alkenyl group can be an unsubstituted alkenyl group or a substituted alkenyl group.

As used herein, the term “aryl” refers to monocyclic or polycyclic (e.g., fused bicyclic and fused tricyclic) carbocyclic aromatic ring systems having six to twenty carbon atoms, for example six to fifteen carbon atoms or six to ten carbon atoms. The term Cₙ means the aryl ring structure has “n” carbon atoms and does not include carbons atoms in a substituent. For example, C₆ aryl refers to an aryl group that has 6 carbon atoms in the ring. Examples of aryl groups include, but are not limited to, phenyl, naphthyl, tetrahydronaphthyl, phenanthrenyl, biphenylenyl, indanyl, indenyl, anthracenyl, and fluorenyl. Unless otherwise indicated, an aryl group can be an unsubstituted aryl group or a substituted aryl group.

As used herein, the term “heteroaryl” refers to a cyclic aromatic ring system having five to twenty total ring atoms (e.g., a monocyclic aromatic ring with 5-6 total ring atoms), of which 1, 2, 3, 4, or 5 of those atoms are heteroatoms independently selected from the group consisting of oxygen, nitrogen, and sulfur, and the remaining atoms in the ring are carbon atoms. Unless otherwise indicated, a heteroaryl group can be unsubstituted or substituted with one or more, and in particular one to four, substituents selected from, for example, halo, alkyl, alkenyl, OCF₃, NO₂, CN, NC, OH, alkoxy, amino, CO₂H, CO₂alkyl, aryl, and heteroaryl. In some cases, the heteroaryl group is substituted with one or more of alkyl and alkoxy groups. Heteroaryl groups can be isolated (e.g., pyridyl) or fused to another heteroaryl group (e.g., purinyl), a cycloalkyl group (e.g., tetrahydroquinolinyl), a heterocycloalkyl group (e.g., dihydronaphthyridinyl), and/or an aryl group (e.g., benzothiazolyl and quinolyl). Examples of heteroaryl groups include, but are not limited to, thienyl, furyl, pyridyl, pyrrolyl, oxazolyl, quinolyl, thiophenyl, isoquinolyl, indolyl, triazinyl, triazolyl, isothiazolyl, isoxazolyl, imidazolyl, benzothiazolyl, pyrazinyl, pyrimidinyl, thiazolyl, and thiadiazolyl. When a heteroaryl group is fused to another heteroaryl group, then each ring can contain five to twenty total ring atoms and one to five heteroatoms in its aromatic ring.

As used herein, the term “hydroxy” or “hydroxyl” refers to the “—OH” group. As used herein, the term “thiol” refers to the “—SH” group.

As used herein, the term “alkoxy” or “alkoxyl” refers to a “—O-alkyl” group. As used herein, the term “aryloxy” or “aryloxyl” refers to a “—O-aryl” group. As used herein, the term “heteroaryloxy” or “heteroaryloxyl” refers to a “—O-heteroaryl” group.

As used herein, the term “alkylthio” refers to a “—S-alkyl” group. As used herein, the term “arylthio” refers to a “—S-aryl” group.

As used herein, the term “halo” is defined as fluoro, chloro, bromo, and iodo. The term “haloalkyl” refers to an alkyl group that is substituted with at least one halogen, and includes perhalogenated alkyl (i.e., all hydrogen atoms substituted with halogen), for example, CH₃CHCl₂, CH₂ICHBr₂CH₃, or CF₃.

As used herein, the term “oxo” refers to a ═O group.

As used herein, the term “amino” refers to a —NH₂ group, wherein one or both hydrogens can be replaced with an alkyl, cycloalkyl, aryl, heterocycloalkyl, or heteroaryl group. As used herein, the term “amido” refers to an amino group that is substituted with a carbonyl moiety (e.g., —NRC(═O) or —C(═O)—NR), wherein R is a substituent on the nitrogen (e.g., alkyl or H). As used herein “imine” refers to a —N(R)═CR₂ group, wherein each R is independently a H, alkyl, cycloalkyl, aryl, heterocycloalkyl, or heteroaryl group. When referring to a ligand, the term “amine” refers to a —NH₃ group, where one, two, or three hydrogens can be replaced with an alkyl, cycloalkyl, aryl, heterocycloalkyl, or heteroaryl group. When referring to a ligand, the term “amide” refers to a NR₂ group, wherein each R is independently a hydrogen, alkyl, cycloalkyl, aryl, heterocycloalkyl, or heteroaryl group.

As used herein, the term “phosphine” refers to a —PH₃ group, wherein 0, 1, 2, or 3 hydrogens can be replaced with an alkyl, cycloalkyl, aryl group, heterocycloalkyl, or heteroaryl. As used herein “phosphite” refers to a —P(OR)₃ group, wherein each R can individually be an alkyl, cycloalkyl, aryl, heterocycloalkyl, or heteroaryl group. As used herein, “phosphonite” refers to a —PR(OR)₂ group, wherein each R can individually be an alkyl, cycloalkyl, aryl, heterocycloalkyl, or heteroaryl group. As used herein, “phosphinite” refers to a —PR₂(OR) group, wherein each R can individually be alkyl, cycloalkyl, aryl, heterocycloalkyl, or heteroaryl group. As used herein, the term “diphosphine” refers to a —P(R₂)—(CH₂)ₙ—P(R₂)— group, wherein each R can individually be an alkyl, cycloalkyl, aryl, heterocycloalkyl, or heteroaryl group and n can be 1, 2, 3, 4, or 5.

As used herein, the term “carbene” refers to a —CH₂ ligand, wherein 0, 1, or 2 hydrogens can be replaced with an alkyl, cycloalkyl, aryl, heterocycloalkyl, or heteroaryl group.

As used herein, the term “N-heterocyclic carbene” refers to a carbene, wherein the carbene is a ring atom in a heterocycle comprising 1 to 5 nitrogen atoms. Examples of N-heterocyclic carbenes include, but are not limited to,

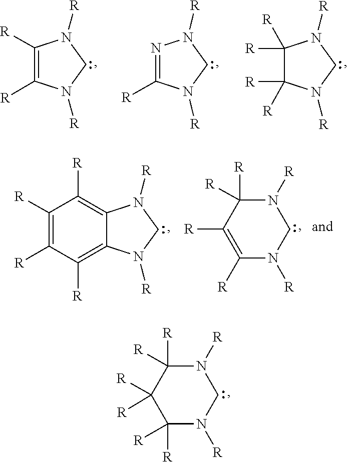

wherein, each R group is independently selected from the group of: H, alkyl, cycloalkyl, alkenyl, aryl, alkoxy, aryloxy, heterocycloalkyl, and heteroaryl.

As used herein, the term “metallacycle” refers to a cycloalkyl or a heterocycloalkyl wherein one of the ring atoms is replaced by a metal atom.

As used herein, the term “substituted,” when used to modify a chemical functional group, refers to the replacement of at least one hydrogen radical on the functional group with a substituent. Substituents can include, but are not limited to, alkyl, cycloalkyl, alkenyl, cycloalkenyl, alkynyl, heterocycloalkyl, heterocycloalkenyl, ether, polyether, thioether, polythioether, aryl, heteroaryl, hydroxyl, oxy, alkoxy, heteroalkoxy, aryloxy, heteroaryloxy, ester, thioester, carboxy, cyano, nitro, amino, amido, acetamide, and halo (e.g., fluoro, chloro, bromo, or iodo). When a chemical functional group includes more than one substituent, the substituents can be bound to the same carbon atom or to two or more different carbon atoms.

As used herein, “bidentate ligand” refers to a ligand that has two atoms that can coordinate directly to the metal center of a metal complex, e.g., a single molecule which can form two bonds to a metal center. Non-limiting examples of bidentate ligands include ethylenediamine, bipyridine, phenanthroline, and diphosphine.

A “neutral ligand,” as used herein, refers to a ligand that, when provided as a free molecule, does not bear a charge. Examples of neutral ligands include, but are not limited to, water, phosphines, ethers (e.g., tetrahydrofuran), and amines (e.g., pyridine, triethylamine, or the like). An “anionic ligand” refers to a ligand that, when provided as a free molecule, has a formal charge of −1. Examples of anionic ligands include, but are not limited to, chloride, methoxy, ethoxy, ispropoxy, tertbutoxy, tertbutyl, neopentyl, triflate, and cyclopentadienyl.

### Compounds of the Disclosure

Provided herein are compounds having a structure represented by formula (I) or dimers thereof:

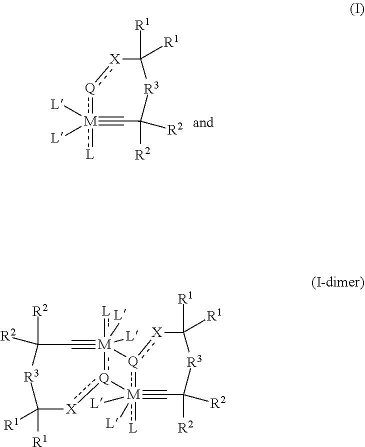

wherein the dashed lines are optional double bonds;
M is a transition metal;
L is a neutral or anionic ligand;
each L′ is independently absent or a neutral or anionic ligand;
Q is selected from S, O, N, NR⁵, N(R⁵)₂, P(R⁶)₂, C, CR⁷, C(R⁷)₂, BR⁸, Si(R⁹)₂, Se, and Te;
X is selected from a bond, S, O, N, NR⁵, Se, Te, C₁-C₄haloalkyl, C₁-C₄alkyl, C₂-C₄alkenyl, C₄-C₁₀cycloalkyl, Ar¹, C₁-C₄heteroalkyl comprising 1 to 5 heteroatoms selected from O, N, and S, and C₁-C₈heterocycloalkyl comprising 1 to 5 heteroatoms selected from O, N, and S;
R³ is selected from a bond, —C(R¹)₂—, —C(R¹)₂C(R¹)₂—, —C(R¹)₂C(R¹)₂C(R¹)₂—, —C(R¹)₂C(R¹)₂C(R¹)₂C(R¹)₂—, and —C(R¹)₂C(R¹)₂C(R¹)₂C(R¹)₂C(R¹)₂—;
each R¹ is independently selected from H, C₁-C₂₀haloalkyl, C₁-C₂₀alkyl, C₂-C₂₀alkenyl, C₄-C₂₀cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two geminal R¹ together with the carbon atom to which they are attached, form a five- to eight-member cycloalkyl or heterocycloalkyl comprising 1 to 5 heteroatoms selected from O, N, and S, or two vicinal R¹ together with the carbon atoms to which they are attached, form a six-member aryl or heteroaryl comprising 1 to 4 heteroatoms selected from O, N, and S, or a five- to eight-member cycloalkyl or heterocycloalkyl comprising 1 to 5 heteroatoms selected from O, N, and S;
each R² is independently selected from H, C₁-C₂₀haloalkyl, C₁-C₂₀alkyl, C₂-C₂₀alkenyl, C₄-C₂₀cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S, or both R² together with the carbon atoms to which they are attached, form a five- to eight-member cycloalkyl or heterocycloalkyl comprising 1 to 5 heteroatoms selected from O, N, and S;
each R⁶ and R⁹ are independently selected from C₁-C₂₂ alkyl, C₄-C₈ cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two vicinal R⁵, two vicinal R⁶, two vicinal R⁸, or two vicinal R⁹, together with the atoms to which they are attached, form a five- to eight-member cycloalkyl, aryl, heteroaryl, or heterocycloalkyl comprising 1 to 5 heteroatoms selected from O, N, and S;
each R⁵, R⁷, and R⁸ are independently selected from H, C₁-C₂₂ alkyl, C₄-C₈ cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two vicinal R⁷ together with the atoms to which they are attached, form a five- to eight-member cycloalkyl, aryl, heteroaryl, or heterocycloalkyl comprising 1 to 5 heteroatoms selected from O, N, and S; and,
each Ar¹ is independently selected from C₆-C₂₂ aryl and a 5-12 membered heteroaryl comprising from 1 to 3 ring heteroatoms selected from O, N, and S.

In general, M is a transition metal. In embodiments, M is selected from chromium (Cr), molybdenum (Mo), tungsten (W), iron (Fe), ruthenium (Ru), rhodium (Rh), iridium (Ir), and osmium (Os). In embodiments, M is Mo or W.

In general, Q is a neutral or anionic ligand. The neutral ligands of the disclosure can be L-type ligands. L-type ligands are known in the art and described in detail throughout, for example, Gray L. Spessard and Gary L. Miessler, Organometallic Chemistry, published by Oxford University Press, 2016, incorporated herein by reference. In embodiments, Q is selected from S, O, N, NR⁵, N(R⁵)₂, P(R⁶)₂, C, CR⁷, C(R⁷)₂, BR⁸, Si(R⁹)₂, Se, and Te. In embodiments, Q is selected from S, O, N, NR⁵, P(R⁶)₂, C, CR⁷, C(R⁷)₂, and BR⁸. In some embodiments, Q is O, N, or NR⁵. In embodiments, M is Mo or W and Q is O, N, or NR⁵.

In general, X is selected from a bond, S, O, N, NR⁵, Se, Te, C₁-C₄haloalkyl, C₁-C₄alkyl, C₂-C₄alkenyl, C₄-C₁₀cycloalkyl, Ar¹, C₁-C₄heteroalkyl comprising 1 to 5 heteroatoms selected from O, N, and S, and C₁-C₈heterocycloalkyl comprising 1 to 5 heteroatoms selected from O, N, and S. In embodiments, X is selected from, C₁-C₄alkyl, O, NR⁵, C₄-C₁₀cycloalkyl, Ar¹ or C₁-C₈heterocycloalkyl comprising 1 to 5 heteroatoms selected from O, N, and S. In embodiments, X is C₁-C₄alkyl,

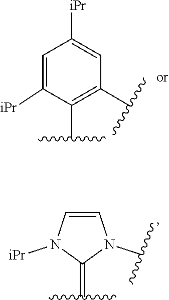 [SMILES: *c1cc(C(C)C)cc(C(C)C)c1* ; *N1C=CN(C(C)C)C1=*]

In embodiments, M is Mo or W, Q is O, N, or NR⁵, and X is C₁-C₄alkyl,

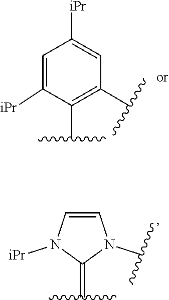 [SMILES: *c1cc(C(C)C)cc(C(C)C)c1* ; *N1C=CN(C(C)C)C1=*]

In general, each R¹ is independently selected from H, C₁-C₂₀haloalkyl, C₁-C₂₀alkyl, C₂-C₂₀alkenyl, C₄-C₂₀cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two geminal R¹ together with the carbon atom to which they are attached, form a five- to eight-member cycloalkyl or heterocycloalkyl comprising 1 to 5 heteroatoms selected from O, N, and S, or two vicinal R¹ together with the carbon atoms to which they are attached, form a six-member aryl or heteroaryl comprising 1 to 4 heteroatoms selected from O, N, and S, or a five- to eight-member cycloalkyl or heterocycloalkyl comprising 1 to 5 heteroatoms selected from O, N, and S. In embodiments, each R¹ is independently selected from H, C₁-C₂₀alkyl, C₁-C₂₀haloalkyl, C₄-C₂₀cycloalkyl, or Ar¹ or two vicinal R¹ together with the carbon atoms to which they are attached, form a six-member aryl or heteroaryl comprising 1 to 4 heteroatoms selected from O, N, and S, or a five- to eight-member cycloalkyl or heterocycloalkyl comprising 1 to 5 heteroatoms selected from O, N, and S. In embodiments, at least one R¹ is H, C₁-C₅haloalkyl, C₁-C₆alkyl or C₄-C₈cycloalkyl, or Ar¹. In embodiments, each R¹ is H, CH₃, Ph, or CF_{3′} or two vicinal R¹ together with the carbon atoms to which they are attached, form a six-member aryl or heteroaryl comprising 1 to 4 heteroatoms selected from O, N, and S. In embodiments, at least one R¹ is H, CH₃, Ph, or CF₃. In embodiments, each R¹ is H.

In general, each R² is independently selected from H, C₁-C₂₀haloalkyl, C₁-C₂₀alkyl, C₂-C₂₀alkenyl, C₄-C₂₀cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S, or both R² together with the carbon atoms to which they are attached, form a five- to eight-member cycloalkyl or heterocycloalkyl comprising 1 to 5 heteroatoms selected from O, N, and S. In embodiments, each R² is independently selected from H, C₁-C₂₀alkyl, C₁-C₂₀haloalkyl, C₄-C₂₀cycloalkyl, or Ar¹. In embodiments, at least one R² is H, C₁-C₅haloalkyl, C₁-C₆alkyl or C₄-C₅cycloalkyl, or Ar¹. In embodiments, at least one R² is H, CH₃, Ph, or CF₃. In embodiments, each R² is H. In embodiments, each R² is CH₃. In embodiments, M is Mo or W, Q is O, N, or NR⁵, X is C₁-C₄alkyl,

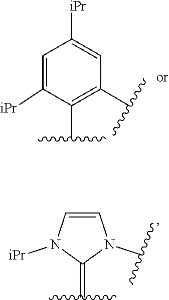 [SMILES: *c1cc(C(C)C)cc(C(C)C)c1* ; *N1C=CN(C(C)C)C1=*]

and each R² are H, CH₃, Ph, or CF₃.

In general, R³ is selected from a bond, —C(R¹)₂—, —C(R¹)₂C(R¹)₂—, —C(R¹)₂C(R¹)₂C(R¹)₂—, —C(R¹)₂C(R¹)₂C(R¹)₂C(R¹)₂—, and —C(R¹)₂C(R¹)₂C(R¹)₂C(R¹)₂C(R¹)₂—. In embodiments, R³ can be selected from —C(R¹)₂—, —C(R¹)₂C(R¹)₂—, —C(R¹)₂C(R¹)₂C(R¹)₂—, or —C(R¹)₂C(R¹)₂C(R¹)₂C(R¹)₂—. In embodiments, R³ is —C(R¹)₂— or —C(R¹)₂C(R¹)₂—. In embodiments, R³ is —C(R¹)₂, and two vicinal R¹ together with the carbon atoms to which they are attached, form a six-member aryl or heteroaryl comprising 1 to 4 heteroatoms selected from O, N, and S, or a five- to eight-member cycloalkyl or heterocycloalkyl comprising 1 to 5 heteroatoms selected from O, N, and S. In embodiments, R³ is —C(R¹)₂, and two vicinal R¹ together with the carbon atoms to which they are attached, form a six-member aryl or heteroaryl comprising 1 to 4 heteroatoms selected from O, N, and S. In embodiments, M is Mo or W, Q is O, N, or NR⁵, X is C₁-C₄alkyl,

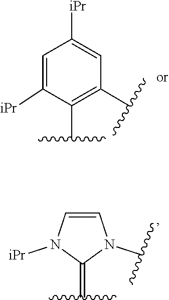 [SMILES: *c1cc(C(C)C)cc(C(C)C)c1* ; *N1C=CN(C(C)C)C1=*]

each R² are H, CH₃, Ph, or CF₃, R³ is —C(R¹)₂— or —C(R¹)₂C(R¹)₂—, and each R¹ is H, CH₃, Ph, or CF_{3′} or two vicinal R¹ together with the carbon atoms to which they are attached, form a six-member aryl or heteroaryl comprising 1 to 4 heteroatoms selected from O, N, and S.

In general, L is a neutral or anionic ligand. The neutral ligands of the disclosure can be L-type ligands. L-type ligands are well known in the art and described in detail throughout, for example, Gray L. Spessard and Gary L. Miessler, Organometallic Chemistry, published by Oxford University Press, 2016, incorporated herein by reference. In embodiments, L comprises one or more functional groups selected from the group of amine, amide, imide, phosphine, phosphite, phosphinite, phosphonite, N-heterocyclic carbene, hydroxyl, oxo, alkoxide, aryloxide, thiol, alkylthiol, arylthiol, carbene, alkyl, cycloalkyl, aryl, heteroaryl, and heterocycloalkyl.

In embodiments, L is an anionic ligand. In embodiments, L is selected from the group of N(R⁵)₂, N(R⁵), OR¹⁰, SR¹¹, O, S, OS(O₂)CF₃, carbene, N-heterocyclic carbene, C₁-C₂₂ alkyl, C₄-C₈ cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S, wherein each of R¹⁰ and R¹¹ are independently selected from C₁-C₂₂ alkyl, C₄-C₈ cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S. In embodiments, L is selected from the group of N(R⁵)₂, N(R⁵), OR¹⁰, SR¹¹, OS(O₂)CF₃, carbene, N-heterocyclic carbene, wherein each of R¹⁰ and R¹¹ are independently selected from C₁-C₂₂ alkyl, C₄-C₈ cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S. In embodiments, L is selected from the group of N(R⁵), OR¹⁰, OS(O₂)CF₃, carbene, and N-heterocyclic carbene, wherein R¹⁰ is selected from C₁-C₂₂ alkyl, C₄-C₈ cycloalkyl, Ar¹ and C₁-C₂₀heterocycloalkyl comprising 1 to 5 heteroatoms selected from O, N, and S. In embodiments, L is selected from the group of N(R⁵), OS(O₂)CF₃, and OR¹⁰, wherein R¹⁰ is selected from C₁-C₂₂ alkyl and Ar¹. In embodiments, L is selected from the group of N(R⁵), OS(O₂)CF₃, and OR¹⁰, wherein R¹⁰ is selected from tert-butyl, phenyl, and substituted phenyl and R⁵ is selected from Ar¹ and C₄-C₈ cycloalkyl. In embodiments, L is N(R⁵) wherein R⁵ is selected from Ar¹ and C₄-C₈ cycloalkyl. In embodiments, M is Mo or W, Q is O, N, or NR⁵, X is C₁-C₄alkyl,

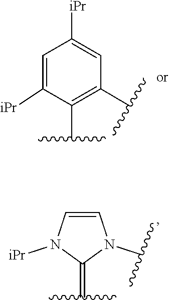 [SMILES: *c1cc(C(C)C)cc(C(C)C)c1* ; *N1C=CN(C(C)C)C1=*]

each R² are H, CH₃, Ph, or CF₃, R³ is —C(R¹)₂— or —C(R¹)₂C(R¹)₂—, each R¹ is H, CH₃, Ph, or CF_{3′} or two vicinal R¹ together with the carbon atoms to which they are attached, form a six-member aryl or heteroaryl comprising 1 to 4 heteroatoms selected from O, N, and S, and L is selected from the group of N(R⁵), OS(O₂)CF₃, and OR¹⁰, wherein R¹⁰ is selected from tert-butyl, phenyl, and substituted phenyl and R⁵ is selected from Ar¹ and C₄-C₈ cycloalkyl.

In general, each L′ is independently absent or a neutral or anionic ligand. In embodiments, at least one L′ is a neutral ligand. The neutral ligands of the disclosure can be L-type ligands. L-type ligands are well known in the art and described in detail throughout, for example, Gray L. Spessard and Gary L. Miessler, Organometallic Chemistry, published by Oxford University Press, 2016, incorporated herein by reference. In embodiments, each L′ is independently absent or comprises one or more functional groups selected from the group of amine, amide, imide, phosphine, phosphite, phosphinite, phosphonite, N-heterocyclic carbene, hydroxyl, oxo, alkoxide, aryloxide, thiol, alkylthiol, arylthiol, carbene, alkyl, cycloalkyl, aryl, heteroaryl, and heterocycloalkyl.

In embodiments, at least one L′ is an anionic ligand. In embodiments, each L′ is independently absent or selected from the group of N(R⁵)₃, N(R⁵)₂, N(R⁵), O(R¹⁰)₂, OR¹⁰, S(R¹¹)₂, SR¹¹, OS(O₂)CF₃, N-heterocyclic carbene, C₁-C₂₂ alkyl, C₄-C₈ cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S, and C₄-C₈heteroaryl comprising 1 to 5 heteroatoms selected from O, N, and S, wherein each of R¹⁰ and R¹¹ are independently selected from C₁-C₂₂ alkyl, C₄-C₈ cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two R¹⁰ together with the oxygen atom(s) to which they are attached form a four- to eight-member ring or bidentate ligand. In embodiments, each L′ is independently absent or selected from the group of N(R⁵)₃, N(R⁵)₂, O(R¹⁰)₂, OR¹⁰, S(R¹¹)₂, SR¹¹, OS(O₂)CF₃, C₁-C₂₂ alkyl, C₄-C₈ cycloalkyl, Ar¹, C₄-C₈heteroaryl, C₁-C₂₀heteroalkyl comprising 1 to 5 heteroatoms selected from O, N, and S, and C₁-C₂₀heterocycloalkyl comprising 1 to 5 heteroatoms selected from O, N, and S, wherein each of R¹⁰ and R¹¹ are independently selected from C₁-C₂₂ alkyl, C₄-C₈ cycloalkyl, Ar¹, C₄-C₈heteroaryl, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two R¹⁰ together with the oxygen atom(s) to which they are attached form a four- to eight-member ring or bidentate ligand.

In embodiments, at least one L′ is independently selected from N(R⁵)₃, N(R⁵)₂, O(R¹⁰)₂, OR¹⁰, N-heterocyclic carbene, or C₁-C₆ alkyl. In embodiments, at least one L′ is independently selected from Ar¹, C₄-C₈heteroaryl, O(R¹⁰)₂, OR¹⁰, or C₁-C₆ alkyl, wherein each of R¹⁰ is independently selected from C₁-C₂₂ alkyl, Ar¹, or two R¹⁰ together with the oxygen atom(s) to which they are attached form a four- to eight-member ring or bidentate ligand. In embodiments, at least one L′ is independently selected from pyridine, tetrahydrofuran, tert-butyl, or two L′ together form —OCH₂CH₂O—. In embodiments, M is Mo or W, Q is O, N, or NR⁵, X is C₁-C₄alkyl,

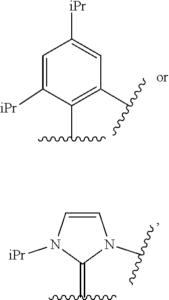 [SMILES: *c1cc(C(C)C)cc(C(C)C)c1* ; *N1C=CN(C(C)C)C1=*]

each R² are H, CH₃, Ph, or CF₃, R³ is —C(R¹)₂— or —C(R¹)₂C(R¹)₂—, each R¹ is H, CH₃, Ph, or CF_{3′} or two vicinal R¹ together with the carbon atoms to which they are attached, form a six-member aryl or heteroaryl comprising 1 to 4 heteroatoms selected from O, N, and S, L is selected from the group of N(R⁵), OS(O₂)CF₃, and OR¹⁰, wherein R¹⁰ is selected from tert-butyl, phenyl, and substituted phenyl and R⁵ is selected from Ar¹ and C₄-C₈ cycloalkyl, and L′ are independently absent or selected from Ar¹, C₄-C₈heteroaryl, O(R¹⁰)₂, OR¹⁰, or C₁-C₆ alkyl, wherein each of R¹⁰ is independently selected from C₁-C₂₂ alkyl, Ar¹, or two R¹⁰ together with the oxygen atom(s) to which they are attached form a four- to eight-member ring or bidentate ligand.

The disclosure further provides compounds selected from the group of:

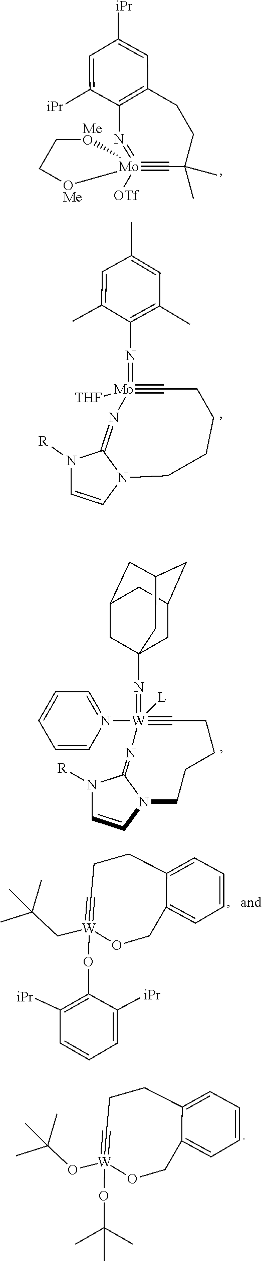

The compounds of the disclosure can be present as a monomer or a dimer. As used herein, the term “dimer(s)” refers to an oligomer consisting of two monomers joined by bonds that can be either strong or weak, covalent or intermolecular. The compounds of the disclosure can comprise homodimers, i.e. the dimer comprises two identical monomers. The compounds of the disclosure can comprise cyclic dimers, i.e. the dimer comprises two monomers connected through two or more sites on each monomer. Generally, the compounds of the disclosure can form dimers in solution; however, the compounds of the disclosure can also be present as monomers.

In various embodiments, the compound is a dimer. In some embodiments, the compound is a dimer having a structure represented by formula (I-dimer):

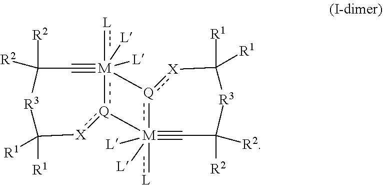

In various embodiments, the compound is a dimer with the structure:

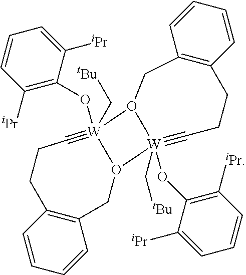

### Synthesizing Compounds of Formula (I)

The disclosure further provides methods of making the compound having a structure represented by formula (I), the method includes admixing a compound of formula (II) and a compound of formula (III) to form a compound of formula (IV) or dimer thereof, and admixing a compound of formula (IV), or dimer thereof with a deprotonating agent to form the compound of formula (I), or dimer thereof:

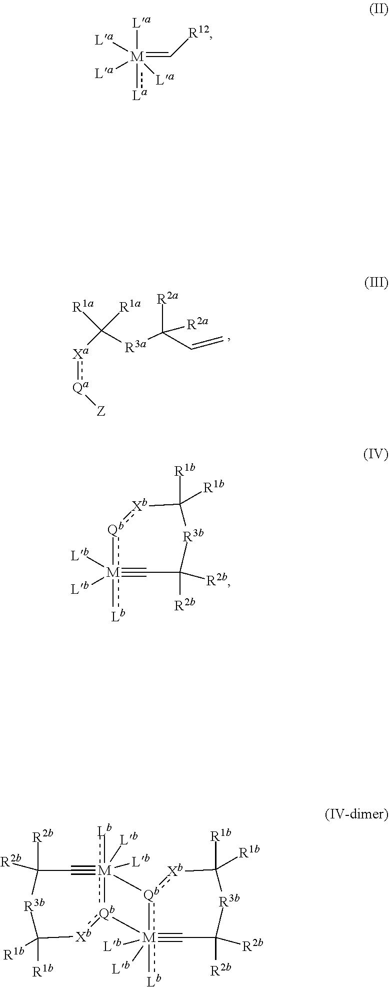

wherein the dashed lines are optional double bonds;
M is a transition metal;
L^{a} and L^{b} are neutral or anionic ligands;
each L′^{a} is independently absent or a neutral or anionic ligand;
each L′^{b} is independently absent or a neutral or anionic ligand;
Q^{a} and Q^{b} are selected from S, O, N, NR^{5a}, N(R^{5a})₂, P(R^{6a})₂, C, CR^{7a}, C(R^{7a})₂, BR^{8a}, Si(R^{9a})₂, Se, and Te;
Z is selected from H, halo, or a counterion for Q^{a};
X^{a} and X^{b} are selected from S, O, N, NR^{5a}, Se, Te, C₁-C₄haloalkyl, C₁-C₄alkyl, C₂-C₄alkenyl, C₄-C₁₀cycloalkyl, Ar^{1a}, C₁-C₄heteroalkyl comprising 1 to 5 heteroatoms selected from O, N, and S, and C₁-C₈heterocycloalkyl comprising 1 to 5 heteroatoms selected from O, N, and S;
R^{3a} and R^{3b} are selected from a bond, —C(R^{1a})₂—, —C(R^{1a})₂C(R^{1a})₂—, —C(R^{1a})₂C(R^{1a})₂C(R^{1a})₂—, —C(R^{1a})₂C(R^{1a})₂C(R^{1a})₂C(R^{1a})₂—, and —C(R^{1a})₂C(R^{1a})₂C(R^{1a})₂C(R^{1a})₂C(R^{1a})₂—;
each R^{1a} and R^{1b} are independently selected from H, C₁-C₂₀haloalkyl, C₁-C₂₀alkyl, C₂-C₂₀alkenyl, C₄-C₂₀cycloalkyl, Ar^{1a}, C₁-C₂₀heteroalkyl comprising 1 to 5 heteroatoms selected from O, N, and S, and C₁-C₂₀heterocycloalkyl comprising 1 to 5 heteroatoms selected from O, N, and S, two geminal R^{1a} together with the carbon atoms to which they are attached, form a five- to eight-member cycloalkyl or heterocycloalkyl comprising 1 to 5 heteroatoms selected from O, N, and S, or two vicinal R^{1a} together with the carbon atoms to which they are attached, form a six-member aryl or heteroaryl comprising 1 to 4 heteroatoms selected from O, N, and S, or a five- to eight-member cycloalkyl or heterocycloalkyl comprising 1 to 5 heteroatoms selected from O, N, and S;
each R^{2a} and R^{2b} is independently selected from H, C₁-C₂₀haloalkyl, C₁-C₂₀alkyl, C₂-C₂₀alkenyl, C₄-C₂₀cycloalkyl, Ar^{1a}, C₁-C₂₀heteroalkyl comprising 1 to 5 heteroatoms selected from O, N, and S, and C₁-C₂₀heterocycloalkyl comprising 1 to 5 heteroatoms selected from O, N, and S, or both R^{2a} together with the carbon atoms to which they are attached, form a five- to eight-member cycloalkyl or heterocycloalkyl comprising 1 to 5 heteroatoms selected from O, N, and S;
each R^{5a}, R^{6a}, R^{7a}, R^{8a} and R^{9a} is independently selected from C₁-C₂₂ alkyl, C₄-C₈ cycloalkyl, Ar^{1a}, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two vicinal R^{5a}, two vicinal R^{6a}, two vicinal R^{7a}, two vicinal R^{8a}, or two vicinal R^{9a}, together with the atoms to which they are attached, form a five- to eight-member cycloalkyl, aryl, heteroaryl, or heterocycloalkyl comprising 1 to 5 heteroatoms selected from O, N, and S;
each Ar^{1a} is independently selected from C₆-C₂₂ aryl and a 5-12 membered heteroaryl comprising from 1 to 3 ring heteroatoms selected from O, N, and S.

In general, L^{a} and L^{b} can be any ligand as defined herein for L. L^{a} and L^{b} can comprise one or more functional groups selected from the group of amine, amide, imide, phosphine, phosphite, phosphinite, phosphonite, N-heterocyclic carbene, hydroxyl, oxo, alkoxide, aryloxide, thiol, alkylthiol, arylthiol, carbene, alkyl, cycloalkyl, aryl, heteroaryl, and heterocycloalkyl. L^{a} and L^{b} can be L-type ligands. L-type ligands are well known in the art and described in detail throughout, for example, Gray L. Spessard and Gary L. Miessler, Organometallic Chemistry, published by Oxford University Press, 2016, incorporated herein by reference. In embodiments, L^{a} and L^{b} are the same.

In embodiments, L^{a} and/or L^{b} is an anionic ligand. In embodiments, L^{a} and/or L^{b} is selected from the group of N(R^{5a})₂, N(R^{5a}), OR^{10a}, SR^{11a}, O, S, OS(O₂)CF₃, carbene, N-heterocyclic carbene, C₁-C₂₂ alkyl, C₄-C₈ cycloalkyl, Ar^{1a}, C₁-C₂₀heteroalkyl comprising 1 to 5 heteroatoms selected from O, N, and S, and C₁-C₂₀heterocycloalkyl comprising 1 to 5 heteroatoms selected from O, N, and S, wherein each of R^{10a} and R^{11a} are independently selected from C₁-C₂₂ alkyl, C₄-C₈ cycloalkyl, Ar^{1a}, C₁-C₂₀heteroalkyl comprising 1 to 5 heteroatoms selected from O, N, and S, and C₁-C₂₀heterocycloalkyl comprising 1 to 5 heteroatoms selected from O, N, and S. In embodiments, L^{a} and/or L^{b} is selected from the group of N(R^{5a})₂, N(R^{5a}), OR^{10a}, SR^{11a}, OS(O₂)CF₃, carbene, N-heterocyclic carbene, wherein each of R¹⁰ and R¹¹ are independently selected from C₁-C₂₂ alkyl, C₄-C₈ cycloalkyl, Ar^{1a}, C₁-C₂₀heteroalkyl comprising 1 to 5 heteroatoms selected from O, N, and S, and C₁-C₂₀heterocycloalkyl comprising 1 to 5 heteroatoms selected from O, N, and S. In embodiments, L^{a} and/or L^{b} is selected from the group of N(R^{5a}), OR^{10a}, OS(O₂)CF₃, carbene, and N-heterocyclic carbene, wherein R^{10a} is selected from C₁-C₂₂ alkyl, C₄-C₈ cycloalkyl, Ar^{1a} and C₁-C₂₀heterocycloalkyl comprising 1 to 5 heteroatoms selected from O, N, and S. In embodiments, L^{a} and/or L^{b} is selected from the group of N(R^{5a}), OS(O₂)CF₃, and OR^{10a}, wherein R^{10a} is selected from C₁-C₂₂ alkyl and Ar^{1a}. In embodiments, L^{a} and/or L^{b} is selected from the group of N(R^{5a}), OS(O₂)CF₃, and OR^{10a}, wherein R^{10a} is selected from tert-butyl, phenyl, and substituted phenyl and R⁵ is selected from Ar^{1a} and C₄-C₈ cycloalkyl. In embodiments, L^{a} and/or L^{b} is N(R^{5a}) wherein R^{5a} is selected from Ar^{1a} and C₄-C₈ cycloalkyl. Ar^{1a} can be any Ar¹ as defined herein. R^{5a} can be any R⁵ as defined herein.

In general, L′^{a} and L′^{b} can be any ligand as defined herein for L′. When present, L′^{a} and L′^{b} can be neutral ligands or an anionic ligands. The neutral ligands of the disclosure can be L-type ligands. L-type ligands are well known in the art and are described in detail throughout, for example, Gray L. Spessard and Gary L. Miessler, Organometallic Chemistry, published by Oxford University Press, 2016, incorporated herein by reference. In embodiments, each L′^{a} and L′^{b} is independently absent or comprises one or more functional groups selected from the group of amine, amide, imide, phosphine, phosphite, phosphinite, phosphonite, N-heterocyclic carbene, hydroxyl, oxo, alkoxide, aryloxide, thiol, alkylthiol, arylthiol, carbene, alkyl, cycloalkyl, aryl, heteroaryl, and heterocycloalkyl.

In embodiments, at least one L′^{a} and L′^{b} is an anionic ligand and at least one L′^{a} and L′^{b} is a neutral ligand. In embodiments, each L′^{a} and/or L′^{b} is independently absent or selected from the group of N(R^{5a})₃, N(R^{5a})₂, N(R^{5a}), O(R^{10a})₂, OR^{10a}, S(R^{11a})₂, SR^{11a}, OS(O₂)CF₃, N-heterocyclic carbene, C₁-C₂₂ alkyl, C₄-C₈ cycloalkyl, Ar^{1a}, C₁-C₂₀heteroalkyl comprising 1 to 5 heteroatoms selected from O, N, and S, and C₁-C₂₀heterocycloalkyl comprising 1 to 5 heteroatoms selected from O, N, and S, wherein each of R^{10a} and R^{11a} are independently selected from C₁-C₂₂ alkyl, C₄-C₈ cycloalkyl, Ar^{1a}, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two R¹⁰ together with the oxygen atom(s) to which they are attached form a four- to eight-member ring or bidentate ligand. In embodiments, each L′^{a} and/or L′^{b} is independently absent or selected from the group of N(R^{5a})₃, N(R^{5a})₂, O(R^{10a})₂, OR^{10a}, S(R^{11a})₂, SR^{11a}, OS(O₂)CF₃, C₁-C₂₂ alkyl, C₄-C₈ cycloalkyl, Ar^{1a}, C₄-C₈heteroaryl, C₁-C₂₀heteroalkyl comprising 1 to 5 heteroatoms selected from O, N, and S, and C₁-C₂₀heterocycloalkyl comprising 1 to 5 heteroatoms selected from O, N, and S, wherein each of R^{10a} and R^{11a} are independently selected from C₁-C₂₂ alkyl, C₄-C₈ cycloalkyl, Ar^{1a}, C₄-C₈heteroaryl, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two R^{10a} together with the oxygen atom(s) to which they are attached form a four- to eight-member ring or bidentate ligand.

In embodiments, at least one L′^{a} and L′^{b} is independently selected from N(R^{5a})₃, N(R^{5a})₂, O(R^{10a})₂, OR^{10a}, N-heterocyclic carbene, or C₁-C₆ alkyl. In embodiments, at least one L′^{a} and/or L′^{b} is independently selected from Ar^{1a}, C₄-C₈heteroaryl, O(R^{10a})₂, OR^{10a}, or C₁-C₆ alkyl, wherein each of R¹⁰ is independently selected from C₁-C₂₂ alkyl, Ar^{1a}, or two R^{10a} together with the oxygen atom(s) to which they are attached form a four- to eight-member ring or bidentate ligand. In embodiments, at least one L′^{a} and/or L′^{b} is independently selected from pyridine, tetrahydrofuran, tert-butyl, or two L′^{a} and/or L′^{b} together form —OCH₂CH₂O—. In embodiments, each L′^{b} corresponds to (e.g., is the same as) an L′^{a}.

In general, Q^{a} and Q^{b} can be any ligand as defined herein for Q. Q^{a} and Q^{b} can be neutral or anionic ligands. The neutral ligands of the disclosure can be L-type ligands as disclosed herein. Generally, Q^{a} and Q^{b} are selected from S, O, N, NR^{5a}, N(R^{5a})₂, P(R^{6a})₂, C, CR^{7a}, C(R^{7a})₂, BR^{8a}, Si(R^{9a})₂, Se, and Te. In embodiments, Q^{a} and Q^{b} are selected from S, O, N, NR^{5a}, P(R^{6a})₂, C, CR^{7a}, C(R^{7a})₂, and BR^{8a}. In embodiments, Q^{a} and Q^{b} are selected from O, N, or NR^{5a}. In embodiments, Q^{a} and Q^{b} are the same. R^{6a}, R^{7a}, R^{8a}, and R^{9a} can be any R⁶, R⁷, R⁸, or R⁹ as defined herein, respectively.

In general, X^{a} and X^{b} are selected from a bond, S, O, N, NR^{5a}, Se, Te, C₁-C₄haloalkyl, C₁-C₄alkyl, C₂-C₄alkenyl, C₄-C₁₀cycloalkyl, Ar^{1a}, C₁-C₄heteroalkyl comprising 1 to 5 heteroatoms selected from O, N, and S, and C₁-C₈heterocycloalkyl comprising 1 to 5 heteroatoms selected from O, N, and S. In embodiments, X^{a} and X^{b} are selected from C₁-C₄alkyl, O, NR^{5a}, C₄-C₁₀cycloalkyl, Ar^{1a}, or C₁-C₈heterocycloalkyl comprising 1 to 5 heteroatoms selected from O, N, and S. In embodiments, X^{a} and X^{b} are C₁-C₄alkyl,

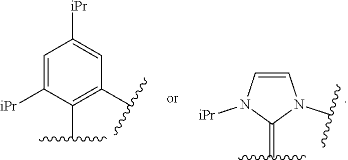 [SMILES: *c1cc(C(C)C)cc(C(C)C)c1* ; *N1C=CN(C(C)C)C1=*]

In general, Z is selected from H, halo, or a counterion for Q^{a}. In embodiments, Z is H or a counterion for Q^{a}. In embodiments, Z is Li, Na, or K.

In general, each R^{1a} and R^{1b} can be any R¹ as defined herein. R^{1a} and R^{1b} can be independently selected from H, C₁-C₂₀haloalkyl, C₁-C₂₀alkyl, C₂-C₂₀alkenyl, C₄-C₂₀cycloalkyl, Ar^{1a}, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two geminal R^{1a} or R^{1b} together with the carbon atoms to which they are attached, form a five- to eight-member cycloalkyl or heterocycloalkyl comprising 1 to 5 heteroatoms selected from O, N, and S, or two vicinal R^{1a} or R^{1b} together with the carbon atoms to which they are attached, form a six-member aryl or heteroaryl comprising 1 to 4 heteroatoms selected from O, N, and S, or a five- to eight-member cycloalkyl or heterocycloalkyl comprising 1 to 5 heteroatoms selected from O, N, and S.

In embodiments, each R^{1a} and R^{1b} is independently selected from H, C₁-C₂₀alkyl, C₁-C₂₀haloalkyl, C₄-C₂₀cycloalkyl, or Ar^{1a} or two vicinal R^{1a} or R^{1b} together with the carbon atoms to which they are attached, form a six-member aryl or heteroaryl comprising 1 to 4 heteroatoms selected from O, N, and S, or a five- to eight-member cycloalkyl or heterocycloalkyl comprising 1 to 5 heteroatoms selected from O, N, and S. In embodiments, at least one R^{1a} and/or R^{1b} is H, C₁-C₅haloalkyl, C₁-C₆alkyl or C₄-C₈cycloalkyl, or Ar^{1a}. In embodiments, at least one R^{1a} and/or R^{1b} is H, C₁-C₅haloalkyl, C₁-C₆alkyl or C₄-C₈cycloalkyl, or Ar^{1a}. In embodiments, each R^{1a} and/or R^{1b} is H, CH₃, Ph, or CF_{3′} or two vicinal R^{1a} or R^{1b} together with the carbon atoms to which they are attached, form a six-member aryl or heteroaryl comprising 1 to 4 heteroatoms selected from O, N, and S. In embodiments, at least one R^{1a} and/or R^{1b} is H, CH₃, Ph, or CF₃. In embodiments, each R^{1a} and/or R^{1b} is H. In embodiments, each R^{1b} corresponds to (e.g., is the same as) an R^{1a}.

In general, each R^{2a} and R^{2b} can be any R² as defined herein. R^{2a} and R^{2b} can be independently selected from H, C₁-C₂₀haloalkyl, C₁-C₂₀alkyl, C₂-C₂₀alkenyl, C₄-C₂₀cycloalkyl, Ar^{1a}, C₁-C₂₀heteroalkyl comprising 1 to 5 heteroatoms selected from O, N, and S, and C₁-C₂₀heterocycloalkyl comprising 1 to 5 heteroatoms selected from O, N, and S, or both R^{2a} together with the carbon atoms to which they are attached, form a five- to eight-member cycloalkyl or heterocycloalkyl comprising 1 to 5 heteroatoms selected from O, N, and S.

In embodiments, each R^{2a} and/or R^{2b} is independently selected from H, C₁-C₂₀alkyl, C₁-C₂₀haloalkyl, C₄-C₂₀cycloalkyl, or Ar^{1a}. In embodiments, at least one R^{2a} and/or R^{2b} is H, C₁-C₅haloalkyl, C₁-C₆alkyl or C₄-C₈cycloalkyl, or Ar^{1a}. In embodiments, at least one R^{2a} and/or R^{2b} is H, CH₃, Ph, or CF₃. In embodiments, each R^{2a} and/or R^{2b} is H. In embodiments, each R^{2a} and/or R^{2b} is CH₃. In embodiments, each R^{2b} corresponds to (e.g., is the same as) an R^{2a}.

In general, R^{3a} and R^{3b} can be any R³ as defined herein. R^{3a} and/or R^{3b} can be selected from a bond, —C(R^{1a})₂—, —C(R^{1a})₂C(R^{1a})₂—, —C(R^{1a})₂C(R^{1a})₂C(R^{1a})₂—, —C(R^{1a})₂C(R^{1a})₂C(R^{1a})₂C(R^{1a})₂—, and —C(R^{1a})₂C(R^{1a})₂C(R^{1a})₂C(R^{1a})₂C(R^{1a})₂—. In embodiments, R^{3a} and/or R^{3b} is —C(R^{1a})₂—, —C(R^{1a})₂C(R^{1a})₂—, —C(R^{1a})₂C(R^{1a})₂C(R^{1a})₂—, or —C(R^{1a})₂C(R^{1a})₂C(R^{1a})₂C(R^{1a})₂—. In embodiments, R^{3a} and/or R^{3b} is —C(R^{1a})₂— or —C(R^{1a})₂C(R^{1a})₂—. In embodiments, R^{3a} and/or R^{3b} is —C(R^{1a})₂, and two vicinal R^{1a} together with the carbon atoms to which they are attached, form a six-member aryl or heteroaryl comprising 1 to 4 heteroatoms selected from O, N, and S, or a five- to eight-member cycloalkyl or heterocycloalkyl comprising 1 to 5 heteroatoms selected from O, N, and S. In embodiments, R^{3a} and/or R^{3b} is —C(R¹)₂, and two vicinal R^{1a} together with the carbon atoms to which they are attached, form a six-member aryl or heteroaryl comprising 1 to 4 heteroatoms selected from O, N, and S. In embodiments, each R^{3b} corresponds to (e.g., is the same as) an R^{3a}.

In general, each R^{5a}, R^{6a}, R^{7a}, R^{8a}, and R^{9a} can be any R⁵, R⁶, R⁷, R⁸, and R⁹ disclosed herein, respectively. In embodiments, each R^{5a}, R^{6a}, R^{7a}, R^{8a}, and R^{9a} is independently selected from C₁-C₂₂ alkyl, C₄-C₈ cycloalkyl, Ar^{1a}, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two vicinal R^{5a}, two vicinal R^{6a}, two vicinal R^{7a}, two vicinal R^{8a}, or two vicinal R^{9a}, together with the atoms to which they are attached, form a five- to eight-member cycloalkyl, aryl, heteroaryl, or heterocycloalkyl comprising 1 to 5 heteroatoms selected from O, N, and S.

In general, M is a transition metal. In embodiments, M is selected from chromium (Cr), molybdenum (Mo), tungsten (W), iron (Fe), ruthenium (Ru), rhodium (Rh), iridium (Ir), and osmium (Os). In embodiments, M is Mo or W.

In general, the deprotonating agent comprises an ylide, LiN(SiMe₃)₂, or KH. In embodiments, the deprotonating agent is Ph₃P═CH₂.

In general, the compound of formula (II) and the compound of formula (III) can be admixed under conditions sufficient to form a compound having a structure represented by formula (I) or dimer thereof. In embodiments, the admixing comprises a molar ratio of the compound of formula (II) and the compound of formula (III) of at least about 1:0.8, respectively. In embodiments, the admixing compromises the compound of formula (II) and the compound of formula (III) in a molar ratio of at least 1:0.8, or in a range of about 1:0.8 to about 1:1.5. In general, increasing the concentration of the compound of formula (II) can increase the rate the reaction to form the compound of formula (I) or dimer thereof; however, as the concentration of the compound of formula (III) increases, the likelihood of intermolecular reactions also increases, such as, the aggregation of multiple metal complexes, or over ligation of the metal center with the compound of formula (III).

In general, about one molar equivalent (e.g., at least 0.8 molar equivalents) of the compound of formula (III) per molar equivalent of the compound of formula (II) can be used to form the compound of formula (I) or dimer thereof.

In general, the compound of formula (IV) or dimer thereof and the deprotonating agent can be admixed under conditions sufficient to form the compound having a structure represented by formula (I), or dimer thereof. In embodiments, the admixing comprises a molar ratio of the compound of formula (IV) and the deprotonating agent of at least about 1:1, respectively. It will be understood that the molar ratio for admixing a compound of formula (IV) with the deprotonating agent refers to the molar ratio of the total monomers of formula (IV) (whether present as individual compounds or joined as a dimer) to the deprotonating agent. In embodiments, the admixing comprises the compound of formula (IV) and the deprotonating agent in a molar ratio of at least 1:1, or in a range of about 1:1 to about 1:10, or about 1:1 to about 1:5, or about 1:1 to about 1:3. In general, increasing the concentration of deprotonating agent can increase the rate the reaction to form the compound of formula (I); however, as the concentration of the deprotonating agent increases, the likelihood of intermolecular reactions also increases, such as, the aggregation of multiple metal complexes, or over ligation of the metal center with the deprotonating agent.

In general, about one molar equivalent (e.g., at least 1 molar equivalent) of the deprotonating agent per molar equivalent of the compound of formula (IV) can be used to form the compound of formula (I) or dimer thereof.

In embodiments, the admixing of the compound of formula (II) and the compound of formula (III) or the compound of formula (IV) and the deprotonating agent can occur neat, for example, in cases where the compound of formula (II) or the compound of formula (III) or the compound of formula (IV) is a liquid. In embodiments, the admixing of the compound of formula (II) and the compound of formula (III) or the compound of formula (IV) and the deprotonating agent can occur in solution. Suitable solvents include but are not limited to, nonpolar aprotic solvents, such as, benzene, toluene, hexanes, pentanes, trichloromethane, chloro-substituted benzenes, deuterated analogs thereof, or combinations thereof.

In embodiments, the admixing of the compound of formula (II) and the compound of formula (III) comprises a solvent. In refinements of the foregoing embodiments, the solvent comprises a nonpolar aprotic solvent. In further refinements of the foregoing embodiments, the nonpolar aprotic solvent comprises benzene, toluene, hexanes, pentanes, trichloromethane, chloro-substituted benzenes, deuterated analogs thereof, or combinations thereof. In embodiments, the admixing of the compound of formula (IV) and the deprotonating agent comprises a solvent. In refinements of the foregoing embodiments, the solvent comprises a nonpolar aprotic solvent. In further refinements of the foregoing embodiments, the nonpolar aprotic solvent comprises benzene, toluene, hexanes, pentanes, trichloromethane, chloro-substituted benzenes, deuterated analogs thereof, or combinations thereof.

The admixing of the compound of formula (II) and the compound of formula (III), and the compound of formula (IV) and the deprotonating agent can occur at any suitable temperature for any suitable time. It is well understood in the art that the rate of a reaction during admixing can be controlled by tuning the temperature. Thus, in general, as the reaction temperature increases the reaction time can decrease.

Reaction temperatures can be in a range of about −80° C. to about 100° C., about −70° C. to about 80° C., about −50° C. to about 75° C., about −25° C. to about 50° C., about 0° C. to about 35° C., about 5° C. to about 30° C., about 10° C. to about 30° C., about 15° C. to about 25° C., about 20° C. to about 30° C., or about 20° C. to about 25° C., for example, about 0° C., about 5° C., about 10° C., about 15° C., about 20° C., about 25° C., about 30° C., or about 35° C. In embodiments, the admixing of the compound of formula (II) and the compound of formula (III) occurs at a temperature in a range of about 0° C. to about 35° C., or about 10° C. to about 30° C., or about 20° C. to about 30° C. In embodiments, the admixing of the compound of formula (IV) and the deprotonating agent occurs at a temperature in a range of about 0° C. to about 35° C., or about 10° C. to about 30° C., or about 20° C. to about 30° C.

Reaction times can be instantaneous or in a range of about 30 seconds to about 72 hours, about 1 minute to about 72 hours, about 5 minutes to about 72 hours, about 10 minutes to about 48 hours, about 15 minutes to about 24 hours, about 1 minute to about 24 hours, about 5 minutes to about 12 hours, about 10 minutes to about 6 hours, about 20 minutes to about 1 hour, about 20 minutes (min) to about 12 hours (h), about 25 min to about 6 h, or about 30 min to about 3 h, for example, about 30 seconds, 1 min, 5 min, 10 min, 15 min, 20 min, 25 min, 30 min, 35 min, 40 min, 45 min, 50 min, 55 min, 60 min, 75 min, 90 min, 105 min, 2 h, 3 h, 4 h, 5 h, 6 h, 12 h, 18 h, 24 h, 36 h, 48 h, 60 h, or 72 h. When the reaction temperature increases above 100° C., generally the risk of decomposition of the product increases. In embodiments, the admixing of the compound of formula (II) and the compound of formula (III) occurs for a time in a range of about 1 minute to about 24 hours, or about 5 minutes to about 12 hours, or about 10 minutes to about 6 hours, or about 20minutes to about 1 hour. In embodiments, the admixing of the compound of formula (IV) and the deprotonating agent occurs for a time in a range of about 1 minute to about 24 hours, or about 5 minutes to about 12 hours, or about 10 minutes to about 6 hours, or about 20minutes to about 1 hour.

As demonstrated in the examples below, the compounds of formula (I) are dynamic in solution and generally have a dimer structure in the solid state.

### Methods of Using Compounds of Formula (I)

The disclosure further provides a method of preparing a cyclic polymer, the method including admixing a plurality of alkene monomers, alkyne monomers, or both in the presence of the compound of formula (I) or dimer thereof, under conditions sufficient to polymerize the plurality of alkene monomers, alkyne monomers, or both to form the cyclic polymer.

Advantageously, compounds having a structure represented by formula (I), or dimers thereof, can generate high-molecular weight cyclic polymers.

Cyclic polymers can be prepared from any monomer that includes a carbon-carbon double bond or a carbon-carbon triple bond. In embodiments, the admixing comprises a plurality of alkyne monomers. In embodiments, the admixing comprises a plurality of alkene monomers.

Suitable alkyne monomers include, but are not limited to, C₂-C₂₀alkynes, C₈-C₂₀ monocyclic cycloalkynes, 8-20 membered monocyclic heterocycloalkynes comprising one to five ring heteroatoms selected from S, O, and N, C₈-C₂₀polycyclic cycloalkynes, or 8-20 membered polycyclic heterocycloalkynes comprising one or more ring heteroatoms selected from S, O, and N. The alkyne monomers can be substituted or unsubstituted. For example, the plurality of alkyne monomers can include cyclooctyne, cycloocta-1,5-diyne, phenylacetylene or

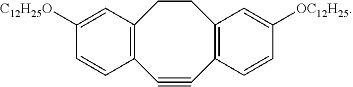

Suitable alkene monomers include, but are not limited to, C₃-C₂₀alkenes, C₅-C₂₀ monocyclic cycloalkenes, 5-20 membered monocyclic heterocycloalkenes comprising one to five ring heteroatoms selected from S, O, and N, C₅-C₂₀polycyclic cycloalkenes, or 5-20 membered polycyclic heterocycloalkenes comprising one or more ring heteroatoms selected from S, O, and N. The alkene monomers can be substituted or unsubstituted. For example, the plurality of alkene monomers can include norbornene or cyclooctene.

The polymerization reaction occurs upon combining in a fluid state the compound having a structure according to formula (I), or dimer thereof, and the plurality of alkenes, alkynes, or both. In some embodiments the reaction can be in neat alkene, alkyne, or both, wherein the monomers are provided in a fluid state. In some embodiments, the reaction can include a solvent such that the fluid state can be in solution.

Examples of solvents that may be used in the polymerization reaction include, but are not limited to, organic (e.g., nonpolar aprotic solvents) that are inert under the polymerization conditions, such as aromatic hydrocarbons, halogenated hydrocarbons, ethers, aliphatic hydrocarbons, or mixtures thereof. In embodiments, the solvent is a nonpolar aprotic solvent. In embodiments, the nonpolar aprotic solvent comprises benzene, toluene, deuterated analogs thereof, or combinations thereof.

The polymerization can be carried out at, for example, ambient temperatures (e.g., about 20° C. to about 25° C.) at dry conditions (e.g., about 0-1% RH) under an inert atmosphere (e.g., nitrogen or argon). Polymerization temperatures can be in a range of about 0° C. to about 35° C., about 10° C. to about 30° C., or about 20° C. to about 30° C. Reaction times can be instantaneous or otherwise until completion. The progress of the reaction can be monitored by standard techniques, e.g., nuclear magnetic resonance (NMR) spectroscopy. In embodiments, the reaction times are in a range of about 30 minutes to about 12 hours, about 1 hour to about 3 hours, about 1 hour to about 10 hours, about 1 hour to about 24 hours, or about 5 hours to about 24 hours. Polymerization times will vary, depending on the particular monomer and the metal complex. The rate of the reaction can decrease if the temperature of the polymerization is below room temperature. Reactions that occur over 100° C. can lead to the catalyst decomposing.

The method of preparing cyclic polymers includes the plurality of alkene monomers, alkyne monomers, or both, and the compound of formula (I), or dimer thereof, in a molar ratio in a range of about 1,000,000:1 to about 10:1, or about 100,000:1 to about 50:1, or about 50,000:1 to about 100:1, or about 50,000:1 to about 500:1, or about 50,000:1 to about 100:1, respectively. For example, the molar ratio of the plurality of alkene monomers, alkyne monomers, or both, to the compound of formula (I), or dimer thereof, is about 1,000,000:1, about 500,000:1, about 100,000:1, about 50,000:1, about 25,000:1, about 10,000:1, about 5,000:1, about 1000:1, about 500:1, or about 100:1.

Polymerization may be terminated at any time by addition of a solvent effective to precipitate the polymer, for example, methanol. The precipitated polymer may then be isolated by filtration or other conventional means.

The molecular weight of the cyclic polymers can be small, equivalent to oligomers of three to ten repeating units, or the molecular weights can be of any size up to tens and hundreds of thousands or millions in molecular weight, for example, in a range of about 200 Da to about 5,000,000 Da, about 500 Da to about 4,000,000 Da, about 1,000 Da to about 3,000,000 Da, about 5,000 Da to about 2,000,000 Da or about 10,000 Da to about 1,000,000 Da. The molecular weight is measured using gel permeation chromatography (GPC) and is calculated in number averaged molecular weight.

The disclosure further provides cyclic polymers, synthesized via the method above including admixing a plurality of alkene monomers, alkyne monomers, or both in the presence of the compound of formula (I), or dimer thereof, under conditions sufficient to polymerize the plurality of alkene monomers, alkyne monomers, or both to form the cyclic polymer, having a structure represented by formula (V) or formula (VI):

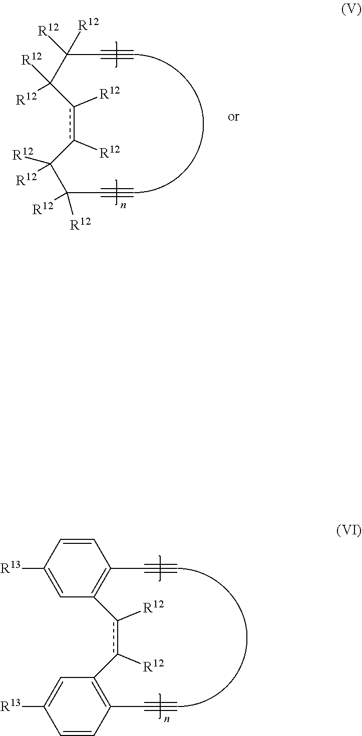

wherein the dashed line is an optional double or triple bond;
each R¹² is independently absent, H, C₁-C₂₀haloalkyl, C₁-C₂₀alkyl, C₂-C₂₀alkenyl, C₄-C₂₀cycloalkyl, aryl, heteroaryl comprising 1 to 5 heteroatoms selected from O, N, and S, C₁-C₂₀alkoxy, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two vicinal R¹² together with the carbon atoms to which they are attached, form a five- to eight-member cycloalkyl, heterocycloalkyl comprising 1 to 5 heteroatoms selected from O, N, and S, aryl, or heteroaryl comprising 1 to 5 heteroatoms selected from O,N, and S;
each R¹³ is independently selected from H, C₁-C₂₀haloalkyl, C₁-C₂₀alkyl, C₂-C₂₀alkenyl, C₄-C₂₀cycloalkyl, aryl, heteroaryl comprising 1 to 5 heteroatoms selected from O, N, and S, C₁-C₂₀alkoxy, C₁-C₂₀heteroalkyl comprising 1 to 5 heteroatoms selected from O, N, and S, and C₁-C₂₀heterocycloalkyl comprising 1 to 5 heteroatoms selected from O, N, and S;
and n is an integer of at least 2.

In general, the dashed line is optionally a double bond or a triple bond. In embodiments, the dashed line can be a double bond. In embodiments, the dashed line can be a triple bond.

In general, each R¹² is independently absent, H, C₁-C₂₀haloalkyl, C₁-C₂₀alkyl, C₂-C₂₀alkenyl, C₄-C₂₀cycloalkyl, aryl, heteroaryl comprising 1 to 5 heteroatoms selected from O, N, and S, C₁-C₂₀alkoxy, C₁-C₂₀heteroalkyl comprising 1 to 5 heteroatoms selected from O, N, and S, or C₁-C₂₀heterocycloalkyl comprising 1 to 5 heteroatoms selected from O, N, and S, or two vicinal R¹² together with the carbon atoms to which they are attached, form a five- to eight-member cycloalkyl, heterocycloalkyl comprising 1 to 5 heteroatoms selected from O, N, and S, aryl, or heteroaryl comprising 1 to 5 heteroatoms selected from O,N, and S. In embodiments, each R¹² is independently absent, H, C₁-C₂₀haloalkyl, C₁-C₂₀alkyl, C₁-C₂₀alkoxy, or C₁-C₂₀heteroalkyl comprising 1 to 5 heteroatoms selected from O, N, and S, or two vicinal R¹² together with the carbon atoms to which they are attached, form a five- to eight-member cycloalkyl, heterocycloalkyl comprising 1 to 5 heteroatoms selected from O, N, and S, aryl, or heteroaryl comprising 1 to 5 heteroatoms selected from O,N, and S. In embodiments, each R¹² is independently absent, H, C₁-C₄haloalkyl, C₁-C₄alkyl, C₁-C₄alkoxy, or C₁-C₄heteroalkyl comprising 1 to 5 heteroatoms selected from O, N, and S, or two vicinal R¹² together with the carbon atoms to which they are attached, form a five- to eight-member cycloalkyl, heterocycloalkyl comprising 1 to 5 heteroatoms selected from O, N, and S, aryl, or heteroaryl comprising 1 to 5 heteroatoms selected from O,N, and S. In embodiments, each R¹² is independently absent, H, C₁-C₄alkyl, or C₁-C₄heteroalkyl comprising 1 to 5 heteroatoms selected from O, N, and S, or two vicinal R¹² together with the carbon atoms to which they are attached, form a five- to eight-member cycloalkyl, heterocycloalkyl comprising 1 to 5 heteroatoms selected from O, N, and S, aryl, or heteroaryl comprising 1 to 5 heteroatoms selected from O,N, and S. In embodiments, each R¹² is independently absent, H, CH₃, or tert-butyl, or two vicinal R¹² together with the carbon atoms to which they are attached, form a five- to eight-member aryl or heteroaryl comprising 1 to 5 heteroatoms selected from O,N, and S. In embodiments, each R¹² is independently absent or H. In embodiments, each R¹² is independently absent or H, or two vicinal R¹² together with the carbon atoms to which they are attached, form a five- to eight-member aryl.

In general, each R¹³ is independently selected from H, C₁-C₂₀haloalkyl, C₁-C₂₀alkyl, C₂-C₂₀alkenyl, C₄-C₂₀cycloalkyl, aryl, heteroaryl comprising 1 to 5 heteroatoms selected from O, N, and S, C₁-C₂₀alkoxy, C₁-C₂₀heteroalkyl comprising 1 to 5 heteroatoms selected from O, N, and S, and C₁-C₂₀heterocycloalkyl comprising 1 to 5 heteroatoms selected from O, N, and S. In embodiments, each R¹³ is independently selected from, H, C₁-C₂₀alkyl, C₄-C₂₀cycloalkyl, aryl, heteroaryl comprising 1 to 5 heteroatoms selected from O, N, and S, C₁-C₂₀alkoxy, C₁-C₂₀heteroalkyl comprising 1 to 5 heteroatoms selected from O, N, and S, and C₁-C₂₀heterocycloalkyl comprising 1 to 5 heteroatoms selected from O, N, and S. In embodiments, each R¹³ is independently selected from, H, C₁-C₁₅alkyl, C₄-C₂₀cycloalkyl, aryl, heteroaryl comprising 1 to 5 heteroatoms selected from O, N, and S, C₁-C₁₅alkoxy, C₁-C₁₅heteroalkyl comprising 1 to 5 heteroatoms selected from O, N, and S, and C₄-C₁₅heterocycloalkyl comprising 1 to 5 heteroatoms selected from O, N, and S.

In general, n is an integer of at least 2. In embodiments, n can be in a range of about 2 to about 5,000,000, about 2 to about 1,000,000, about 2 to about 500,000, about 2 to about 100,000, about 2 to about 50,000, about 5 to about 100,000, about 10 to about 500,000, about 25 to about 250,000, or about 50 to about 50,000.

In embodiments, the cyclic polymer is a compound having the structure:

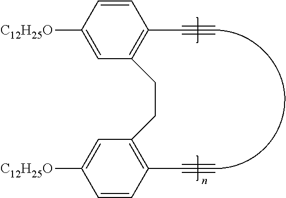

wherein n is an integer of at least 2. This structure may also be represented as the structure:

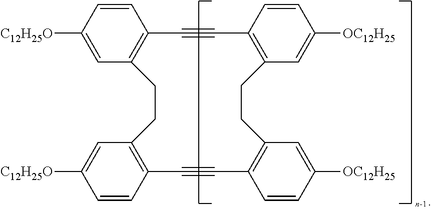

### EXAMPLES

### Materials and Methods

Benzene, hexanes, diethyl ether, tetrahydrofuran, pentane, and toluene were degassed, dried using a GlassContour drying column or equivalent, and stored over 3 Å molecular sieves prior to use. 1,2-benzenedimethanol was purchased from Oakwood Chemical and recrystallized from diethyl ether. W(C^{t}Bu)(CH₂^{t}Bu)(O-2,6-ⁱPr₂C₆H₃) was prepared according to the method published in Tonzetich et. al, Organometallics 2007, 26, 475-477. All other chemicals were used without purification unless otherwise noted.

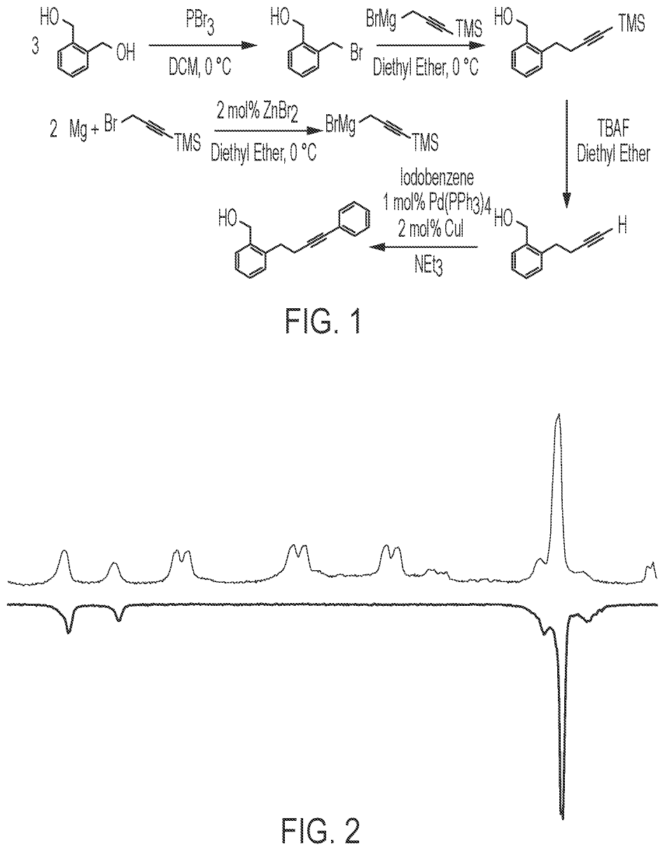

The overall scheme for the ligand synthesis is shown in FIG. 1.

### Example 1—Synthesis of 2-(bromomethyl)benzenemethanol

A 2-neck round bottom flask equipped with a stir bar, septum and stopcock flow adapter under argon was charged with 1,2-benzenedimethanol (7.654 g, 55.402 mmol) and 400 mL of dry dichloromethane. The mixture was stirred and cooled in an ice/water bath, 0° C. Through the septum, phosphorus tribromide (1.75 mL, 18.6 mmol) was added dropwise via syringe to the cold stirring solution. The reaction was stirred at 0° C. for 2 h then warmed naturally to ambient temperature while stirring for 1.5 h. The solution was filtered through silica and the volatiles were removed in vacuo. The products were separated via column chromatography (SiO₂; hexanes/ethyl acetate 17:1). Upon solvent removal in vacuo 2-(bromomethyl)benzenemethanol was obtained.

¹H NMR (300 MHz, C₆D₆): δ 7.15 (s, 1H, Ar—H), 6.99 (td, 1H, J=7.2, 1.9 Hz, Ar—H), 6.96-6.90 (m, 2H, Ar—H), 4.41 (d, 2H, J=5.7 Hz, HO—CH₂⁷), 4.17 (s, 2H, Br—CH₂⁸), 0.87 (d, 1H, J=5.8 Hz, OH).

¹³C NMR (101 MHz, C₆D₆): δ 140.0, 135.8, 130.7, 129.0, 128.6, 62.3, 31.0.

### Example 2—Synthesis of (3-(trimethylsilyl)prop-2-yn-1-yl)magnesium bromide

A dry round bottom flask equipped with a stir bar was charged with zinc bromide (0.059 g, 0.26 mmol), magnesium turnings (0.642 g. 26.4 mmol), dry diethyl ether (10 mL) and fitted with a dropping funnel containing a solution of 3-bromo-1-(trimethylsilyl)-1-propyne (2.511 g, 13.13 mmol) in diethyl ether (8 mL). The apparatus was attached to a Schlenk line under argon and the addition started at ambient temperature. Once an exothermic reaction was observed, the flask was chilled to 0° C. in an ice/water bath. Upon completion of the addition the reaction was stirred for 2 h at 0° C. The concentration was found to be 0.53 M via titration of a water quenched aliquot of the reaction mixture with 0.10 M HCl(aq) with bromomethyl blue as an indicator. The reaction mixture allowed to settle and the solution was cannula transferred into the next reaction step.

### Example 3—Synthesis of (2-(4-(trimethylsilyl)but-3-yn-1-yl)phenyl)methanol

A Schlenk flask equipped with a stir bar was charged with 2-(bromomethyl)-benzenemethanol (0.862 g, 4.28 mmol) as prepared in Example 1, and 30 mL of dry diethyl ether. To the flask was attached an addition funnel and the apparatus was placed on a Schlenk line. The flask was chilled, stirring, in an ice/water bath, 0° C. The solution of the generated Grignard, (3-(trimethylsilyl)prop-2-yn-1-yl)magnesium bromide prepared in Example 2 was transferred to the addition funnel via cannula (approx. 18 mL, 0.72 M). The Grignard solution was added dropwise to the chilled flask with stirring. After the complete addition, the reaction flask was allowed to warm naturally to ambient temperature and stirred overnight (12 hours). Cool deionized (DI) water was added to quench the reaction, and additional ether was added to dilute the organic layer. The organic layer was washed with DI water, brine, and dried over magnesium sulfate. The ether was filtered and the solvent removed in vacuo. The products were separated via column chromatography (SiO₂; hexanes/ethyl acetate 4:1).

¹H NMR (300 MHz, C₆D₆): δ 7.20-7.17 (m, 1H, Ar—H), 7.09-7.04 (m, 2H, Ar—H), 7.02-6.99 (m, 1H, Ar—H), 4.32 (s, 2H, OH—CH₂⁷), 2.71 (t, 2H, J=7.4 Hz, CH₂⁸), 2.36 (t, 2H, J=7.4 Hz, CH₂⁹), 1.08 (s, 1H, OH), 0.18 (s, 9H, TMS).

¹³C NMR (101 MHz, C₆D₆): δ 139.3, 139.0, 129.9, 128.8, 127.9, 126.8, 107.4, 85.6, 63.1, 31.5, 22.1, 0.2.

### Example 4—Synthesis of (2-(but-3-yn-1-yl)phenyl)methanol

In a round bottom flask equipped with a stir bar, 14 mL diethyl ether and (2-(4-(trimethylsilyl)but-3-yn-1-yl)phenyl)methanol (0.213 g, 0.916 mmol) as prepared in Example 3 were added. The solution was stirred and a 1.16 M solution of TBAF in THF (0.95 mL, 1.1 mmol) was added. The mixture quickly turned opaque with a yellow oil on the bottom of the flask and was left stirring overnight (12 hours). The mixture was diluted with ether, and then washed with 1.0 M HCl (20 mL) followed by deionized water and brine. The organic layer was dried over magnesium sulfate, filtered, and then solvents removed in vacuo.

¹H NMR (600 MHz, C₆D₆): δ 7.19 (dd, J=6.9, 2.4 Hz, 1H, Ar—H), 7.09-7.02 (m, 2H, Ar—H), 6.97 (dd, J=7.0, 2.1 Hz, 1H, Ar—H), 4.29 (s, 2H, CH₂⁷), 2.67 (t, J=7.6 Hz, 2H, CH₂⁸), 2.25 (td, J=7.6, 2.6 Hz, 2H, CH₂⁹), 1.75 (t, J=2.7 Hz, 1H, CH¹¹), 1.13 (s, 1H, OH).

¹³C NMR (101 MHz, C₆D₆): δ 139.2, 138.8, 129.6, 128.6, 128.0, 126.8, 84.0, 69.6, 63.0, 31.4, 20.4.

### Example 5—Synthesis of (2-(4-phenylbut-3-yn-1-yl)phenyl)methanol

A round bottom flask equipped with a stir bar was charged with iodobenzene (1.132 g, 5.548 mmol), tetrakistriphenylphosphine palladium(0) (0.0644 g, 0.0557 mmol), copper (I) iodide (0.0211 g, 0.111 mmol), and triethylamine. The mixture was stirred under argon and the (2-(but-3-yn-1-yl)phenyl)methanol (0.8883 g, 5.544 mmol) from Example 4 was added. The opaque yellow mixture was stirred at ambient temperature overnight (12 h). Aqueous NH₃/NH₄Cl (60 mL) was added to quench the reaction and the mixture was extracted with diethyl ether. The ether was dried over sodium sulfate, filtered, and solvent removed in vacuo. The product was purified by column chromatography (SiO₂; hexanes/ethyl acetate 4:1).

¹H NMR (400 MHz, C₆D₆): δ 7.46 (m, 2H, Ar—H), 7.28-7.18 (m, 1H Ar—H), 7.13-6.73 (m, 5H Ar—H), 4.35 (d, J=5.7 Hz, 2H, CH₂⁷), 2.80 (t, J=7.5 Hz, 2H, CH₂⁸), 2.53 (t, J=7.5 Hz, 2H, CH₂⁹), 0.83 (t, J=5.7 Hz, 1H, OH).

¹³C NMR (101 MHz, C₆D₆): δ 139.3, 139.1, 129.8, 128.7, 128.6, 128.0, 127.9, 126.8, 124.6, 90.2, 82.1, 63.1, 31.7, 21.6.

### Example 6—Synthesis of W(CCH₂CH₂C₆H₄-o-CH₂O)(CH^{t}Bu)(O-2,6-ⁱPr₂—C₆H₃)

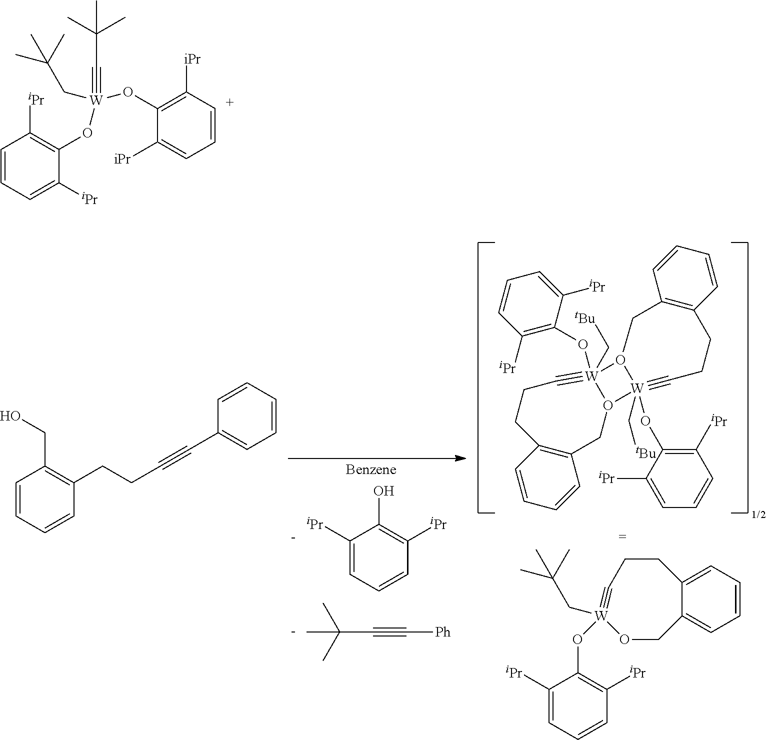

A round bottom flask equipped with stir bar and pressure equalizing dropping funnel was charged with W(C^{t}Bu)(CH₂^{t}Bu)(O-2,6-ⁱPr₂—C₆H₃)₂ (0.208 g, 0.306 mmol) and 5 mL of benzene. A solution of the (2-(4-phenylbut-3-yn-1-yl)phenyl)methanol (0.072 g, 0.304 mmol) prepared in Example 5 in 5 mL benzene was added dropwise via addition funnel with stirring. After stirring for 18 h the volatiles were removed in vacuo. Pentane, 4 mL, was added to the resulting dark viscous residue. The resulting suspension was filtered, and the pale-yellow solid was washed three times with pentane and dried in vacuo. Crystals suitable for single-crystal x-ray analysis were obtained by dissolving the product in warm benzene leaving the solution to sit undisturbed.

¹H NMR (400 MHz, C₆D₆): δ 7.71-7.63 (m, 1H), 7.32 (dd, J=7.8, 1.7 Hz, 1H), 7.20 (dd, J=7.5, 1.8 Hz, 1H), 7.07 (t, J=7.6 Hz, 1H), 7.02-6.89 (m, 2H), 6.86-6.68 (m, 3H), 6.09-5.84 (m, 3H), 3.88-3.84 (m, 1H), 3.70-3.61 (m, 1H), 3.58-3.37 (m, 2H), 3.20-3.07 (m, 1H), 2.14 (d, J=14.9 Hz, 1H), 2.08-2.03 (m, 1H), 1.90 (d, J=14.7 Hz, 1H), 1.69 (d, J=7.0 Hz, 3H), 1.64 (d, J=3.9 Hz, 2H), 1.58 (d, J=4.2 Hz, 1H), 1.51 (d, J=6.7 Hz, 3H), 1.36 (d, J=6.9 Hz, 4H), 1.27 (d, J=6.8 Hz, 3H), 1.07 (s, 9H).

¹H¹³C gHSQC, gHMBC spectra (400 MHz, C₆D₆): δ 286.7, 165.0, 164.0, 142.2, 140.6, 136.2, 136.0, 132.4, 131.1, 130.0, 129.8, 128.7, 126.8, 123.0, 122.8, 85.9, 84.9, 79.1, 46.1, 36.6, 35.7, 35.2, 34.3, 33.7, 33.5, 27.5, 26.5, 26.3, 24.9, 24.8, 24.6, 24.4, 21.5, 20.5 132.6, 130.2, 128.8, 126.9, 122.8, 122.5, 86. 78.8, 46.1, 36.7, 36.6, 34.2, 33.5, 27.5.

The 1-D NOESY/EXSY (500 MHz, toluene-d₈) spectrum is shown in FIG. 2 (bottom), presented for comparison with the ¹H NMR spectrum (top), collected at 80° C. FIG. 2 demonstrates that W(C^{t}Bu)(CH₂^{t}Bu)(O-2,6-ⁱPr₂—C₆H₃)₂ is dynamic in solution. Further, the X-ray structure (FIG. 3) of the product shows that in the solid state, the W(C^{t}Bu)(CH₂^{t}Bu)(O-2,6-ⁱPr₂—C₆H₃)₂ is a dimer, binding through the bridging alkoxides from the cyclic ligand. In FIG. 3, ligand and solvent disorder parts and hydrogen atoms are removed for clarity.

### Example 7—Polymerization of Alkenes and Alkynes

In a nitrogen atmosphere glovebox, a scintillation vial equipped with a stir bar was charged with 3,8-didodecyloxy-5,6-dihydro-11,12-didehydrodibenzo[a,e]-[8]annulen (0.040 g, 0.069 mmol) and 2.0 mL of dry toluene. To this solution was added, in one portion, 0.40 mL of a 3.45 mM toluene stock solution of W(CCH₂CH₂C₆H₄-o-CH₂O)(CH^{t}Bu)(O-2,6-ⁱPr₂—C₆H₃) as prepared in Example 6, with stirring. After 27 m, 2.0 mL of dry toluene were added and the polymer was precipitated in 15 mL methanol with stirring. The polymer was isolated via filtration and washed with additional methanol and dried.

¹H NMR (500 MHz, CDCl₃): δ 7.40 (d, J=8.4 Hz, 2H), 6.69 (d, J=2.7 Hz, 2H), 6.64 (dd, J=8.4, 2.6 Hz, 2H), 3.71 (t, J=6.5 Hz, 4H), 3.21 (s, 4H), 1.60-1.70 (m, 4H), 1.15-1.45 (m, 36H), 0.87 (t, J=7.0 Hz, 6H).

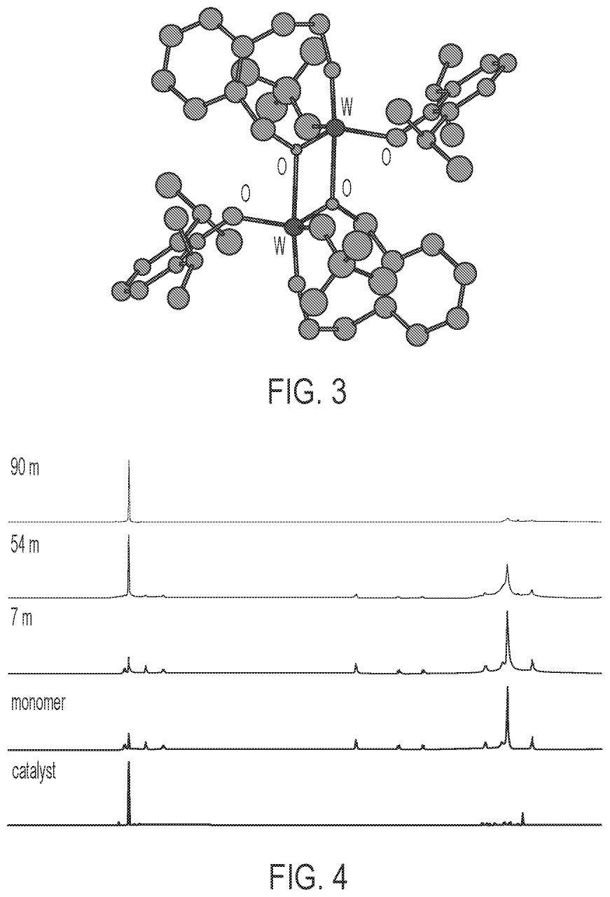

Stacked ¹H NMR (C₆D₆, 500 MHz, 25° C.) spectra are shown in FIG. 4, including W(CCH₂CH₂C₆H₄-o-CH₂O)(CH^{t}Bu)(O-2,6-ⁱPr₂—C₆H₃), (bottom), 3,8-didodecyloxy-5,6-dihydro-11,12-didehydrodibenzo[a,e]-[8]annulen (2^{nd} from the bottom), and polymerization progress (top 3 spectra).

### Example 8—General Conditions for Polymerization of Alkenes and Alkynes

In a nitrogen atmosphere glovebox, scintillation vials equipped with stir bars were charged with 3,8-didodecyloxy-5,6-dihydro-11,12-didehydrodibenzo[a,e]-[8]annulen (15 mg, 0.026 mmol) and 1.0 mL of dry toluene. To these solutions, 100.0 μL of a 5.18 mM toluene stock solution of W(CCH₂CH₂C₆H₄-o-CH₂O)(CH^{t}Bu)(O-2,6-ⁱPr₂—C₆H₃) as prepared in Example 6, was added in one portion with stirring. The vials were sealed and mixed. After the appropriate reaction time, the vials were removed from the glovebox, unsealed and quenched with methanol, 10-12 mL. The polymers were isolated via filtration, washed with additional methanol and dried overnight under vacuum.

The experiment was performed in two separate runs; entries 1-4 were performed in one run while entries 5-9 were performed separately. Reaction times and yields are listed in Table 1.

TABLE 1
Reaction times and yields for the synthesis of
cyclic poly-(o-phenylene ethynylene) with W(CCH₂CH₂C₆H₄-o-
CH₂O)(CH^{t}Bu)(O-2,6-ⁱPr₂—C₆H₃).

| Entry | Reaction Time^{a} | Isolated yield | | Percent yield^{b} |
|---|---|---|---|---|
| c-PoPE-1 | 10 | 14.1 | mg | 94% |
| c-PoPE-2 | 10 | 10.7 | mg | 9.8% |
| c-PoPE-3 | 5 | 9.9 | mg | 17% |
| c-PoPE-4 | 2 | 6.5 | mg | 7.2% |
| c-PoPE-5 | 25 | 14 | mg | 73% |
| c-PoPE-6 | 15 | 13 | mg | 86% |
| c-PoPE-7 | 10 | 12 | mg | 80% |
| c-PoPE-8 | 5 | 13 | mg | 86% |
| c-PoPE-9 | 2 | 11 | mg | 93% |

^{a}Time reported in minutes.
^{b}Determined from isolated yield.

Thus, Example 8 demonstrates general preparation conditions for preparing a cyclic polymer according to the disclosure. The catalysts and polymers of the disclosure are further characterized in Example 9.

### Example 9—Polymerization of Alkenes and Alkynes with W(CCMe₃)(OCMe₃)₃

Additionally, the polymerization of 3,8-didodecyloxy-5,6-dihydro-11,12-didehydrodibenzo[a,e]-[8]annulen was investigated with commercially-available W(CCMe₃)(OCMe₃)₃, following a similar procedure as Example 8.

In a nitrogen atmosphere glovebox, a scintillation vial equipped with a stir bar was charged with 3,8-didodecyloxy-5,6-dihydro-11,12-didehydrodibenzo[a,e]-[8]annulen (15 mg, 0.026 mmol) and 1.0 mL of dry toluene. To this solution 100.0 μL of a 5.29 mM toluene stock solution of W(CCMe₃)(OCMe₃)₃ was added in one portion with stirring. The vial was sealed and mixed. The vial was removed from the glovebox, unsealed and quenched by adding methanol, 10-12 mL after 5 minutes. The polymer was isolated via filtration, washed with additional methanol and dried overnight under vacuum. The results from the W(CCMe₃)(OCMe₃)₃ compound (I-PoPE) were compared with the results obtained for catalysts of the disclosure, (c-PoPE) and are presented in Table 2.

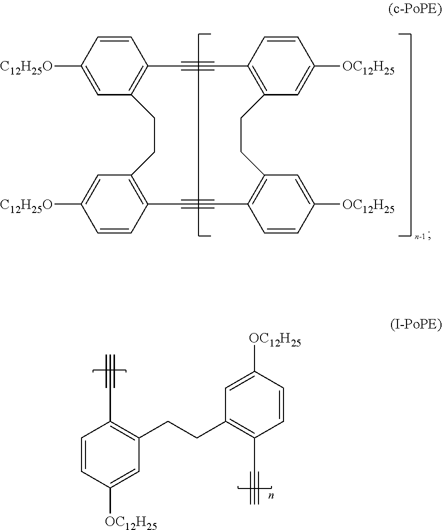

TABLE 2
Catalysis conditions and characterization data for the synthesis
of cyclic and linear poly-(o-phenylene ethynylene).

| Entry | Time^{a} | Mn^{b} | Ð^{b} | DPₙ | %^{d} |
|---|---|---|---|---|---|
| c-PoPE-1 | 10 | 10,900 | 4.76 | 18 | 100 |
| c-PoPE-2 | 10 | 25,100 | 2.68 | 43 | 13 |
| c-PoPE-3 | 5 | 19,400 | 2.28 | 33 | 29 |
| c-PoPE-4 | 2 | 11,900 | 2.54 | 50 | 12 |
| I-PoPE^{c}-1 | 5 | 19,600 | 2.75 | 34 | 100 |
| c-PoPE-5 | 25 | 54,664 | 2.21 | 95 | — |
| c-PoPE-6 | 15 | 56,837 | 3.00 | 99 | — |
| c-PoPE-7 | 10 | 43,366 | 3.19 | 76 | — |
| c-PoPE-8 | 5 | 61,290 | 2.39 | 107 | — |
| c-PoPE-9 | 2 | 44,729 | 1.60 | 253 | — |
| I-PoPE^{c}-2 | 5 | 62,012 | 2.07 | 108 | — |

^{a}Minutes,
^{b}Determined (g/mol) by size-exclusion chromatography (SEC) equipped with differential refractive index (DRI) and viscometry using dichlorobenzene (DCB) as the mobile phase at 140° C.
^{c}Linear generated using W(CCME₃)(OCMe₃)₃.
^{d}% conversion of 3,8-didocdecyloxy-5,6-dihydro-11,12-didehydrodibonzo[a,e]-[8]annulen.

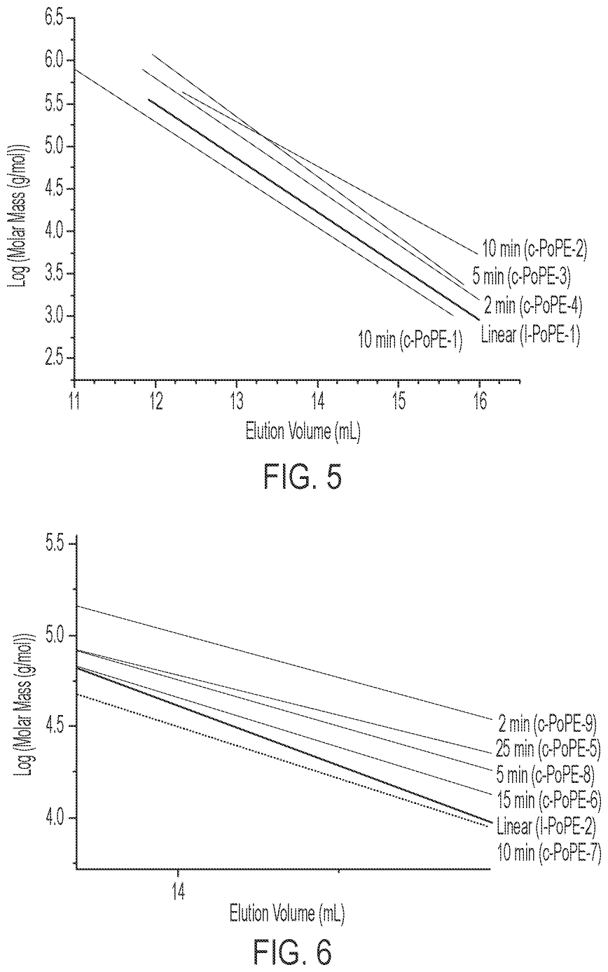

Solution properties of cyclic poly-(o-phenylene ethynylene) were compared with those of linear poly-(o-phenylene ethynylene) via GPC analysis, providing evidence on the polymer cyclic topology. With a smaller hydrodynamic volume, cyclic polymers are expected to elute later than their linear counterparts, for a given molecular weight. As shown in the plot of log MW versus elution volume (FIGS. 5 and 6), for each set of collected data, polymers prepared with catalysts of the invention generally follow this trend. Thus, the data in FIGS. 5 and 6 suggests preparation of high molecular weight cyclic polymers with catalysts of the invention.

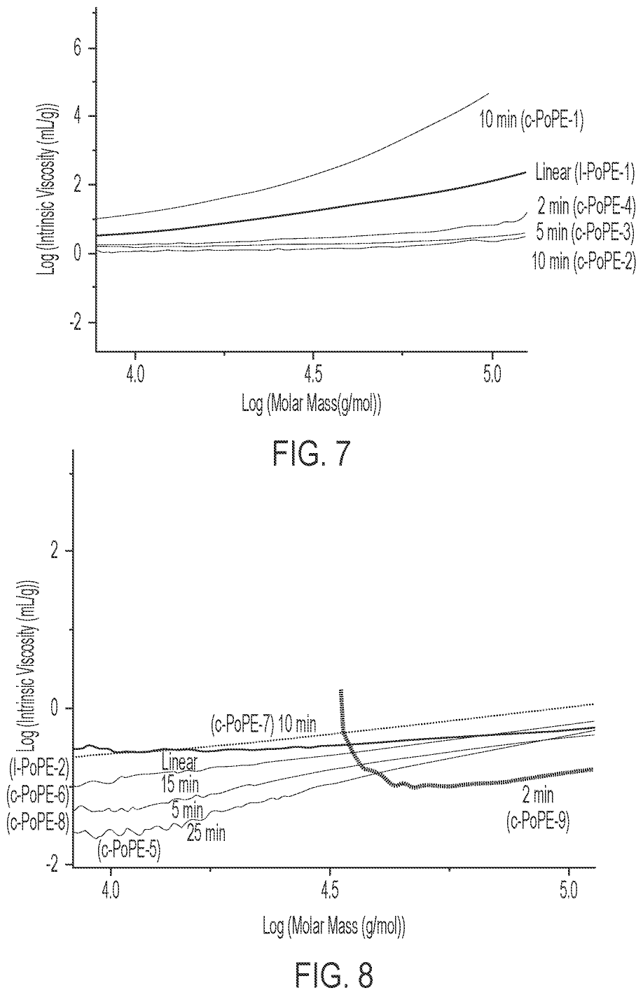

Formation of cyclic poly-(o-phenylene ethynylene) was confirmed by analyzing the intrinsic viscosity of the prepared poly-(o-phenylene ethynylene) in THF using a viscometer-equipped GPC. Due to their smaller overall dimensions, cyclic polymers are expected to exhibit lower intrinsic viscosity compared with analogous linear polymers for a given molecular weight. As shown in the Mark-Houwink-Sakurada plots in FIGS. 7 and 8 where log [n] was plotted vs log M, where [n] was the intrinsic viscosity and M was the viscosity-average molar mass, most of the polymers prepared with the catalyst of the disclosure follow this trend.

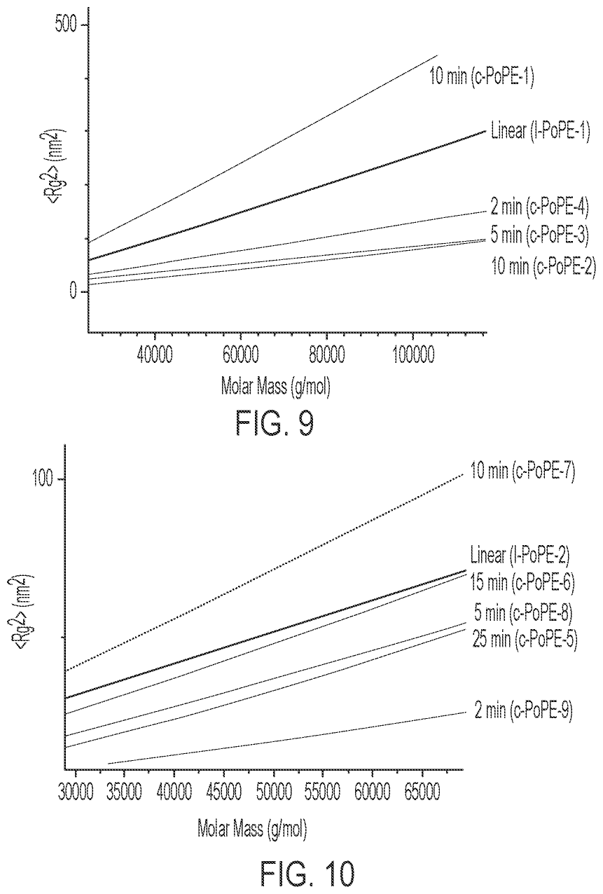

Additionally, as shown in the plots of mean square radius of gyration (<R_{g}²>) versus molar mass (FIGS. 9 and 10) for the prepared poly-(o-phenylene ethynylene), for each set of collected data, most of the polymers prepared with the catalyst of the disclosure exhibit lower mean square radii of gyration than the analogous polymer prepared with a catalyst not of the disclosure.

However, one entry from both runs of Example 8 (c-PoPE-1 and c-PoPE-7) are outliers that do not follow the trend. In the case of these polymers, the generated poly-(o-phenylene ethynylene) had greater intrinsic viscosity than the linear analogue, as shown on the Mark-Houwink-Sakurada plots (FIGS. 7 and 8), as well as a higher mean square radius of gyration than the linear analogue, as shown in FIGS. 9 and 10. Without intending to be bound by theory, it is believed that the polymerization conditions for c-PoPE-1 and c-PoPE-7 can be optimized to produce a polymer with an intrinsic viscosity consistent with the cyclic analogues, for example, by optimizing reaction conditions such as admixing time prior to quenching the solution, as well as the supply of monomer, i.e. constant flow or batch fed addition of monomer, can be further optimized to improve polymerization.

Thus, Example 9 demonstrates preparation of cyclic polymers using a catalyst of the disclosure and linear polymers using a catalyst not of the disclosure.

1. A compound having a structure represented by formula (I) or formula (I-dimer): 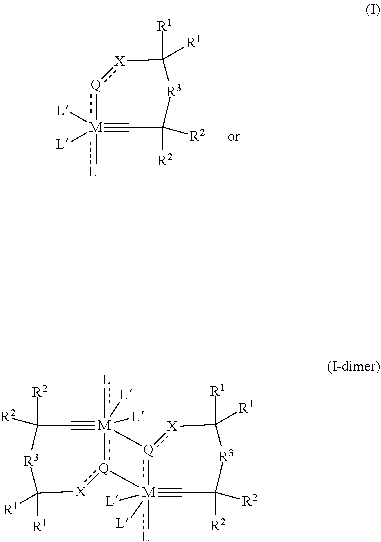
wherein the dashed lines are optional double bonds;
M is a transition metal;
L is a neutral or anionic ligand;
each L′ is independently absent or a neutral or anionic ligand;
Q is selected from S, O, N, NR⁵, N(R⁵)₂, P(R⁶)₂, C, CR⁷, C(R⁷)₂, BR⁸, Si(R⁹)₂, Se, and Te;
X is selected from a bond, S, O, N, NR⁵, Se, Te, C₁-C₄haloalkyl, C₁-C₄alkyl, C₂-C₄alkenyl, C₄-C₁₀cycloalkyl, Ar¹, C₁-C₄heteroalkyl comprising 1 to 5 heteroatoms selected from O, N, and S, and C₁-C₈heterocycloalkyl comprising 1 to 5 heteroatoms selected from O, N, and S;
R³ is selected from a bond, —C(R¹)₂—, —C(R¹)₂C(R¹)₂—, —C(R¹)₂C(R¹)₂C(R¹)₂—, —C(R¹)₂C(R¹)₂C(R¹)₂C (R¹)₂—, and —C(R¹)₂C(R¹)₂C(R¹)₂C(R¹)₂C(R¹)₂—;
each R¹ is independently selected from H, C₁-C₂₀haloalkyl, C₁-C₂₀alkyl, C₂-C₂₀alkenyl, C₄-C₂₀cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two geminal R¹ together with the carbon atom to which they are attached, form a five- to eight-member cycloalkyl or heterocycloalkyl comprising 1 to 5 heteroatoms selected from O, N, and S, or two vicinal R¹ together with the carbon atoms to which they are attached, form a six-member aryl or heteroaryl comprising 1 to 4 heteroatoms selected from O, N, and S, or a five- to eight-member cycloalkyl or heterocycloalkyl comprising 1 to 5 heteroatoms selected from O, N, and S;
each R² is independently selected from H, C₁-C₂₀haloalkyl, C₁-C₂₀alkyl, C₂-C₂₀alkenyl, C₄-C₂₀cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S, or both R² together with the carbon atoms to which they are attached, form a five- to eight-member cycloalkyl or heterocycloalkyl comprising 1 to 5 heteroatoms selected from O, N, and S;
each R⁶ and R⁹ are independently selected from C₁-C₂₂ alkyl, C₄-C₈ cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two vicinal R⁵, two vicinal R⁶, two vicinal R⁸, or two vicinal R⁹, together with the atoms to which they are attached, form a five- to eight-member cycloalkyl, aryl, heteroaryl, or heterocycloalkyl comprising 1 to 5 heteroatoms selected from O, N, and S;
each R⁵, R⁷, and R⁸ are independently selected from H, C₁-C₂₂ alkyl, C₄-C₈ cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two vicinal R⁷ together with the atoms to which they are attached, form a five- to eight-member cycloalkyl, aryl, heteroaryl, or heterocycloalkyl comprising 1 to 5 heteroatoms selected from O, N, and S; and,
each Ar¹ is independently selected from C₆-C₂₂ aryl and a 5-12 membered heteroaryl comprising from 1 to 3 ring heteroatoms selected from O, N, and S.

2. The compound of claim 1, wherein M is selected from Cr, Mo, W, Fe, Ru, Rh, Ir, and Os.

3. (canceled)

4. The compound of claim 1, wherein Q is selected from S, O, N, NR⁵, P(R⁶)₂, C, CR⁷, C(R⁷)₂, and BR⁸.

5. (canceled)

6. The compound of claim 1, wherein X is selected from O, NR⁵, C₄-C₁₀cycloalkyl, Ar¹ or C₁-C₈heterocycloalkyl comprising 1 to 5 heteroatoms selected from O, N, and S.

7. The compound of claim 1, wherein X is

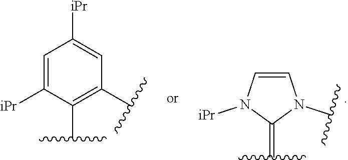 [SMILES: *c1cc(C(C)C)cc(C(C)C)c1* ; *N1C=CN(C(C)C)C1=*]

8. The compound of claim 1, wherein each R¹ is independently selected from H, C₁-C₂₀alkyl, C₁-C₂₀haloalkyl, C₄-C₂₀cycloalkyl, or Ar¹.

9. The compound of claim 8, wherein at least one R¹ is H, C₁-C₅haloalkyl, C₁-C₆alkyl or C₄-C₈cycloalkyl, or Ar¹.

10. (canceled)

11. (canceled)

12. The compound of claim 1, wherein each R² is independently selected from H, C₁-C₂₀alkyl, C₁-C₂₀haloalkyl, C₄-C₂₀cycloalkyl, or Ar¹.

13. The compound of claim 12, wherein at least one R² is H, C₁-C₅haloalkyl, C₁-C₆alkyl or C₄-C₈cycloalkyl, or Ar¹.

14. (canceled)

15. (canceled)

16. The compound of claim 1, wherein R³ is —C(R¹)₂—, —C(R¹)₂C(R¹)₂—, —C(R¹)₂C(R¹)₂C(R¹)₂—, or —C(R¹)₂C(R¹)₂C(R¹)₂C(R¹)₂—.

17. (canceled)

18. The compound of claim 1, wherein L comprises one or more functional groups selected from the group of amine, amide, imide, phosphine, phosphite, phosphinite, phosphonite, N-heterocyclic carbene, hydroxyl, oxo, alkoxide, aryloxide, thiol, alkylthiol, arylthiol, carbene, alkyl, cycloalkyl, aryl, heteroaryl, and heterocycloalkyl.

19. (canceled)

20. The compound of claim 1, wherein L is selected from the group of N(R⁵)₂, N(R⁵), OR¹⁰, SR¹¹, O, S, OS(O₂)CF₃, carbene, N-heterocyclic carbene, C₁-C₂₂ alkyl, C₄-C₈ cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S, wherein each of R¹⁰ and R¹¹ are independently selected from C₁-C₂₂ alkyl, C₄-C₈ cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S.

21. (canceled)

22. The compound of claim 1, wherein each L′ is independently absent or comprises one or more functional groups selected from the group of amine, amide, imide, phosphine, phosphite, phosphinite, phosphonite, N-heterocyclic carbene, hydroxyl, oxo, alkoxide, aryloxide, thiol, alkylthiol, arylthiol, carbene, alkyl, cycloalkyl, aryl, heteroaryl, and heterocycloalkyl.

23. (canceled)

24. (canceled)

25. The compound of claim 22, wherein each L′ is independently selected from the group of N(R⁵)₃, N(R⁵)₂, N(R⁵), O(R¹⁰)₂, OR¹⁰, S(R¹¹)₂, SR¹¹, N-heterocyclic carbene, C₁-C₂₂ alkyl, C₄-C₈ cycloalkyl, Ar¹, C₁-C₂₀heteroalkyl comprising 1 to 5 heteroatoms selected from O, N, and S, C₄-C₈heteroaryl comprising 1 to 5 heteroatoms selected from O, N, and S, and C₁-C₂₀heterocycloalkyl comprising 1 to 5 heteroatoms selected from O, N, and S, wherein each of R¹⁰ and R¹¹ are independently selected from C₁-C₂₂ alkyl, C₄-C₈ cycloalkyl, Ar¹, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two R¹⁰ together with the oxygen atom(s) to which they are attached form a four- to eight-member ring or bidentate ligand.

26. (canceled)

27. The compound of claim 1, selected from the group of:

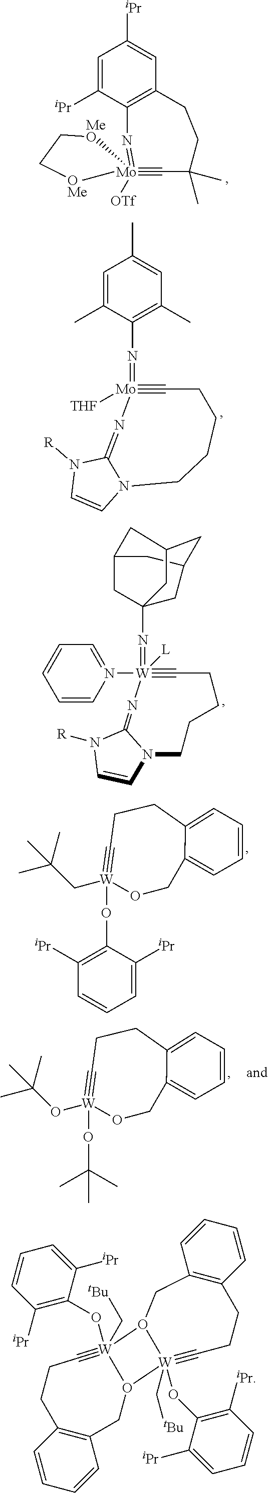

28. A method of preparing the compound of formula (I) according to claim 1, the method comprising:
admixing a compound of formula (II) and a compound of formula (III) to form a compound of formula (IV), or formula (IV-dimer); and,
admixing the compound of formula (IV), or formula (IV-dimer) with a deprotonating agent to form the compound of formula (I): 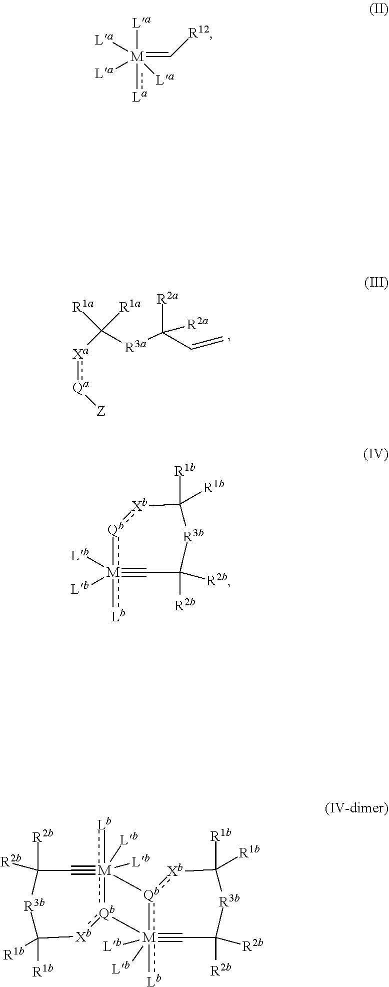
wherein the dashed lines are optional double bonds;
M is a transition metal;
L^{a} and L^{b} are neutral or anionic ligands;
each L′^{a} is independently absent or a neutral or anionic ligand;
each L′^{b} is independently absent or a neutral or anionic ligand;
Q^{a} and Q^{b} are selected from S, O, N, NR^{5a}, N(R^{5a})₂, P(R^{6a})₂, C, CR^{7a}, C(R^{7a})₂, BR^{8a}, Si(R^{9a})₂, Se, and Te;
Z is selected from H, halo, or a counterion for Q^{a};
X^{a} and X^{b} are selected from S, O, N, NR^{5a}, Se, Te, C₁-C₄haloalkyl, C₁-C₄alkyl, C₂-C₄alkenyl, C₄-C₁₀cycloalkyl, Ar^{1a}, C₁-C₄heteroalkyl comprising 1 to 5 heteroatoms selected from O, N, and S, and C₁-C₈heterocycloalkyl comprising 1 to 5 heteroatoms selected from O, N, and S;
R^{3a} and R^{3b} are selected from a bond, —C(R^{1a})₂—, —C(R^{1a})₂C(R^{1a})₂—, —C(R^{1a})₂C(R^{1a})₂C(R^{1a})₂—, —C(R^{1a})₂C(R^{1a})₂C(R^{1a})₂C(R^{1a})₂—, and —C(R^{1a})₂C(R^{1a})₂C(R^{1a})₂C(R^{1a})₂C(R^{1a})₂—;
each R^{1a} and R^{1b} are independently selected from H, C₁-C₂₀haloalkyl, C₁-C₂₀alkyl, C₂-C₂₀alkenyl, C₄-C₂₀cycloalkyl, Ar^{1a}, C₁-C₂₀heteroalkyl comprising 1 to 5 heteroatoms selected from O, N, and S, and C₁-C₂₀heterocycloalkyl comprising 1 to 5 heteroatoms selected from O, N, and S, two geminal R^{1a} or R^{1b} together with the carbon atoms to which they are attached, form a five- to eight-member cycloalkyl or heterocycloalkyl comprising 1 to 5 heteroatoms selected from O, N, and S, or two vicinal R^{1a} or R^{1b} together with the carbon atoms to which they are attached, form a six-member aryl or heteroaryl comprising 1 to 4 heteroatoms selected from O, N, and S, or a five- to eight-member cycloalkyl or heterocycloalkyl comprising 1 to 5 heteroatoms selected from O, N, and S;
each R^{2a} and R^{2b} is independently selected from H, C₁-C₂₀haloalkyl, C₁-C₂₀alkyl, C₂-C₂₀alkenyl, C₄-C₂₀cycloalkyl, Ar^{1a}, C₁-C₂₀heteroalkyl comprising 1 to 5 heteroatoms selected from O, N, and S, and C₁-C₂₀heterocycloalkyl comprising 1 to 5 heteroatoms selected from O, N, and S, or both R^{2a} or R^{2b} together with the carbon atoms to which they are attached, form a five- to eight-member cycloalkyl or heterocycloalkyl comprising 1 to 5 heteroatoms selected from O, N, and S;
each R^{5a}, R^{6a}, R^{7a}, R^{8a} and R^{9a} is independently selected from C₁-C₂₂ alkyl, C₄-C₈ cycloalkyl, Ar^{1a}, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two vicinal R^{5a}, two vicinal R^{6a}, two vicinal R^{7a}, two vicinal R^{8a}, or two vicinal R^{9a}, together with the atoms to which they are attached, form a five- to eight-member cycloalkyl, aryl, heteroaryl, or heterocycloalkyl comprising 1 to 5 heteroatoms selected from O, N, and S;
each Ar^{1a} is independently selected from C₆-C₂₂ aryl and a 5-12 membered heteroaryl comprising from 1 to 3 ring heteroatoms selected from O, N, and S.

29.-69. (canceled)

70. A method of preparing a cyclic polymer, the method comprising:
admixing a plurality of alkene monomers, alkyne monomers, or both in the presence of the compound of formula (I) according to claim 1 to polymerize the plurality of alkene monomers, alkyne monomers, or both to form the cyclic polymer.

71.-79. (canceled)

80. A cyclic polymer prepared according to the method of claim 70.

81. A cyclic polymer having a structure according to formula (V): 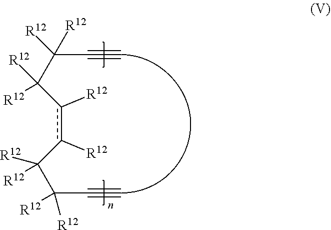
wherein the dashed line is an optional double or triple bond;
each R¹² is independently absent, H, C₁-C₂₀haloalkyl, C₁-C₂₀alkyl, C₂-C₂₀alkenyl, C₄-C₂₀cycloalkyl, aryl, heteroaryl comprising 1 to 5 heteroatoms selected from O, N, and S, C₁-C₂₀alkoxy, C₁-C₂₀heteroalkyl comprising 1 to 5 heteroatoms selected from O, N, and S, or C₁-C₂₀heterocycloalkyl comprising 1 to 5 heteroatoms selected from O, N, and S, or two vicinal R¹² together with the carbon atoms to which they are attached, form a five- to eight-member cycloalkyl, heterocycloalkyl comprising 1 to 5 heteroatoms selected from O, N, and S, aryl, or heteroaryl comprising 1 to 5 heteroatoms selected from O,N, and S;
and n is an integer of at least 2.

82. The cyclic polymer of claim 81 having a structure according to formula (VI): 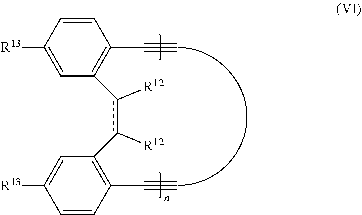
wherein the dashed line is an optional double or triple bond;
each R¹² is independently absent, H, C₁-C₂₀haloalkyl, C₁-C₂₀alkyl, C₂-C₂₀alkenyl, C₄-C₂₀cycloalkyl, aryl, heteroaryl comprising 1 to 5 heteroatoms selected from O, N, and S, C₁-C₂₀alkoxy, C₁-C₂₀heteroalkyl comprising 1 to 5 heteroatoms selected from O, N, and S, and C₁-C₂₀heterocycloalkyl comprising 1 to 5 heteroatoms selected from O, N, and S, or two vicinal R¹² together with the carbon atoms to which they are attached, form a five- to eight-member cycloalkyl, heterocycloalkyl comprising 1 to 5 heteroatoms selected from O, N, and S, aryl, or heteroaryl comprising 1 to 5 heteroatoms selected from O,N, and S;
each R¹³ is independently selected from, H, C₁-C₂₀haloalkyl, C₁-C₂₀alkyl, C₂-C₂₀alkenyl, C₄-C₂₀cycloalkyl, aryl, heteroaryl comprising 1 to 5 heteroatoms selected from O, N, and S, C₁-C₂₀alkoxy, C₁-C₂₀heteroalkyl comprising 1 to 5 heteroatoms selected from O, N, and S, and C₄-C₂₀heterocycloalkyl comprising 1 to 5 heteroatoms selected from O, N, and S;
and n is an integer of at least 2.

83. (canceled)
